(19) United States
(12) Patent Application Publication
(10) Pub. No.: US 2022/0356723 A1
(43) Pub. Date: Nov. 10, 2022

(54) METHOD AND APPARATUS FOR RENOVATION WORKS ON A BUILDING

(71) Applicant: Q-BOT LIMITED, London (GB)

(72) Inventors: Mathew Holloway, London (GB); Elodie Soler, London (GB); Ashley Napier, London (GB)

(73) Assignee: Q-BOT LIMITED, London (GB)

(21) Appl. No.: 17/622,166

(22) PCT Filed: Jun. 24, 2020
(86) PCT No.: PCT/GB2020/051535

§ 371 Date: Dec. 22, 2021

(30) Foreign Application Priority Data
Jun. 25, 2019 (GB) 1909111.5

(51) Int. Cl. E04G 23/02; E04G 21/14

(52) U.S. Cl. CPC E04G 23/0296; E04G 21/14

(57) ABSTRACT

The present application provides a method for renovation works on a building that has a plurality of building elements, for example walls. The method includes: receiving scan data of a building element of the building; (150) processing the scan data to determine at least one dimension of the building element and an initial property of the building element from the scan data; configuring (160) a building system for the building element to achieve a target property of the building element, the building system being configured according to the at least one dimension of the building element and according to the initial property of the building element; and generating instruction data (170) for fabricating the building system. There is also provided an apparatus for renovation works on a building that has a plurality of building elements, for example walls.

This invention relates to a method and apparatus for renovation works on a building, including a method and apparatus for applying a covering to a building element, for example a wall.

### BACKGROUND

Currently, most building renovations are carried out manually on site. A small number of prototype projects have been undertaken where buildings are refurbished using robotic devices. However, building operations on existing buildings, for example installation of external wall insulation, or render, is typically done manually.

Thus, human workers can be required to complete long hours of manual labour to carry out building works, sometimes working in hazardous conditions, such as working at height, or in adverse weather conditions.

Furthermore, it is difficult for human workers to ensure a consistent appearance of a surface of the building before and after rendering the surface, especially if the rendering creates a new surface.

Moreover, when carrying out renovation works a survey is usually conducted to acquire measurements that allow a new part of the building to be built alongside an existing structure, or to allow for a new building to be constructed around the constraints of a given plot of land. For example, for installation of external wall insulation, a frame having insulation panels can be partially constructed to measurements in an offsite location, for example in a factory, and then installed on the building. Render is then manually applied after installation on the building to complete the covering.

It is in this context that the present invention has been devised.

### BRIEF SUMMARY OF THE DISCLOSURE

In accordance with the present disclosure there is provided a method for renovation works on a building comprising a plurality of building elements, for example a plurality of walls. The method comprises: receiving scan data of a building element of the building; processing the scan data to determine at least one dimension of the building element and an initial property of the building element from the scan data; configuring a building system for the building element to achieve a target property of the building element, the building system being configured according to the at least one dimension of the building element and according to the initial property of the building element; and generating instruction data for fabricating the building system. Optionally, the method further includes fabricating the building system in accordance with the instruction data. The method is preferably performed by a processor, for example a processor of a computer.

Thus, the building system for the renovation works can be configured according to the at least one dimension and according to the initial property of the building element as captured in the scan data. In this way, the method provides automated configuration of a building system for the renovation works, and outputs instruction data for fabricating the building system. Preferably, the instruction data is in the form of control data for a computer-controlled apparatus that performs at least a part of the fabrication of the building system. That is, preferably the instruction data is control data for a computer-controlled apparatus to automatically fabricate at least a part of the building system based on the control data. Preferably, the computer-controlled apparatus directly fabricates at least a part of the building system based on the control data.

The term “building element” as used herein means any component of a structure of a building. For example, the building element may be a structural element of a building, for example a wall, a roof, a column, a pillar, a beam and any other structural members of the building, such as a chimney stack. In other examples, the building element may be a non-structural element of a building, for example a window, a window sill, a window frame, a fascia, a gutter, a tile, a panel, a fence, a railing, or a balustrade. Therefore, it will be appreciated that the term “building element” may mean any element of a building.

The term “building system” as used herein means a component or a collection of components that go together to make a building element. For example, for a roof, one or more of the rafters, lining, tiles, ceiling boards, insulation and ceiling finish comprise a building system for the roof (building element). In another example, a wall (building element) is comprised of one or more of structural beams/pillars, blockwork, render, panels, insulation, paint and other components, one or more of which comprise a building system. In another example, a window (building element) is comprised of a window frame, a window sill, and one or more window panes, each of which could be a building system.

The term “dimension” means one or more of a height, a width, and/or a depth of the building element. The dimension may be a total height, width or depth of the building element, or may be a partial dimension of the building element.

The term “property” means a non-dimensional property of the building, for example one or more of a thermal metric of the building element, an appearance of the building element, a material of the building element, a condition of the building element, a structure of the building element, and/or a moisture content of the building element.

A thermal metric of the building element may comprise a surface temperature reading, or it may comprise a thermal performance measurement, for example a U-value.

An appearance of the building element may comprise any of a colour, a texture, a shade or other visual characteristic.

A material of the building element will depend on the type of building element. For example, for a wall the material may for example be any of brick, blockwork, concrete, paneling, tiling, etc. For a window frame, the material may for example be any of wood, plastic, metal, etc.

In examples where the initial property and/or the target property include a condition of the building element, the condition may include visible or invisible deficiencies, such as cracks or other weaknesses, or peeling paint, missing parts, leaks, etc, depending on the type of building element. The initial property and/or target property of a condition of the building element may be a binary condition, such as ‘faulty’ or ‘compliant’. For example, a missing gutter might have an initial property of ‘faulty’ and the target property, following replacement of the missing gutter, would be ‘compliant’.

In examples where the initial property and/or the target property include a structure of the building element, the structure may include attachments between different components of the building element, or location information for structural support elements, such as brackets, beams, studs, or joists. The structure may include information on fixing points for attachment of the building system to the building element.

In examples where the initial property and/or target property include moisture, the moisture may include a damp reading, the location of damp areas, identified by moisture content and/or visual characteristics, and/or other indicators of damp.

The method may further comprise determining the target property from the initial property. The target property may be equivalent to the initial property, for example the target property and the initial property may both be a thermal metric of a wall. Specifically, if the initial property were a thermal metric of the building element, then the target property might be a thermal metric of the building element based on the initial thermal metric. However, it will be appreciated that in some examples the method does not include determining, for example computing or calculating, the target property.

The method may comprise classifying the building element, for example through feature recognition based on the scan data. In this example, the initial property may be based on the classification of the building element. Specifically, a particular classification of building element may be associated with one or more initial conditions. In one example, if the building element is classified as a wall, then the initial property may comprise one or more of thermal performance and appearance. Accordingly, the initial property is based on the classification of the building element.

In some examples, the target property matches the initial property. For example, if the initial property were an appearance of the building element, then the target property may match the initial appearance.

In other examples, the target property may be different from the initial property. For example, the target property may be an improvement of the initial property, for example a better thermal metric or an improved condition of the building element.

In some examples, the target property may not be equivalent to the initial property. For example, the initial property may be a structural property, and the target property may be an appearance. In this way, the building system can be configured based on the initial property, so that the building system can be installed on the building, and the building system will achieve a target appearance.

The target property may be retrieved from a database based on the classification of the building element and the initial property. For example, where the building element is a wall and the initial property is a sub-optimal thermal performance, then the target property may be an improved level of thermal performance that is retrieved from a database.

The method may further comprise scanning the building element using electronic scanning apparatus to generate the scan data. The electronic scanning apparatus may comprise one or more directional sensors. The one or more directional sensors may include a camera. The one or more directional sensors may include a rangefinder sensor, such as a laser rangefinder sensor. The one or more directional sensors may include a thermal imaging sensor. The camera may be an optical camera. The camera may be an infrared camera. Thus, the scan data can include spatial information about the building element, for example one or more dimensions, obtained by the rangefinder sensor and/or an optical camera. Additionally or alternatively, the scan data may include thermal information on the building element, for example surface temperatures. Additionally or alternatively, the scan data may include visual information about the building element, as captured by an optical camera. The visual information can be processed to determine an appearance, or a material of the building element.

Preferably, the scan data comprises a 3D point-cloud of the building element. The 3D point cloud is formed of the spatial information from the rangefinder sensor, and may additionally comprise thermal information, visual information, and other scan data layered onto the 3D point cloud.

Preferably, the method further comprises receiving further scan data after fabrication of the building system, and processing the further scan data to assess a resultant property of the building system for quality control. In this way, a subsequent scan can be used to check that the building system has been properly fabricated and installed.

In some examples, fabricating the building system may comprise fabricating a least a part of the building system in a location remote from the building, for example in a factory. The building system can be partially or completely fabricated in the factory, and subsequently installed on the building element. In other examples, fabricating the building system may comprise fabricating the building element at the location of the building, for example directly on the building element. Fabrication of the building system may comprise installing the building system on the building element. Therefore, in some examples the building system can be at least partially fabricated in an off site location, for example in a factory, and later installed onto the building element. In one example, the building system comprises a covering having insulation panels supported by a frame, and a coating applied over the insulation panels, for example a render. In this example, the frame and insulation panels can be fabricated in a factory, installed on the building element (e.g. a wall) and then the render can be applied. Alternatively, the render could be applied at the factory, and the complete covering can subsequently be installed on the building element.

In some examples, configuring the building system may comprise selecting a building system from a database according to the initial property of the building element. For example, a building system may be selected according to its suitability for use with the building element, as determined by the initial property. The building system may be selected according to a classification of the building element. In other examples, configuring the building system may comprise selecting a building system according to the at least one dimension of the building element, in addition to or instead of the initial property of the building element. For example, a replacement component may be specified according to its dimension, such as a length of replacement gutter. In examples where the method includes determining the target property, configuring the building system may comprise selecting a building system from a database according to the target property. In some examples, configuring the building system may comprise selecting a building system from a database according to the initial property, the at least one dimension, and the target property.

The method of configuring the building system may comprise selecting a material and a quantity of the material for the building system according to the at least one dimension of the building element. In this way, the building system can be configured to be the appropriate size and/or shape for the building element. The method of configuring the building system may additionally or alternatively comprise selecting a material and a quantity of the material for the building system according to the initial property of the building element. In examples where the method includes determining the target property, configuring the building system may comprise selecting a material and a quantity of the material for the building system according to the target property. In some examples, configuring the building system may comprise selecting a material and a quantity of the material for the building system according to the initial property, the at least one dimension, and the target property.

The generated instruction data may comprise control data for a computer-controlled apparatus configured to fabricate at least a part of the building system in accordance with the control data. For example, a robotic device or other computer-controlled apparatus may be configured to operate according to the control data to fabricate at least a part of the building system. In one example, an external wall panel can be fabricated by one or more computer-controlled apparatuses in a factory for later installation on a wall of a building. In other examples, the computer-controlled apparatus may comprise computer-controlled apparatus for applying a coating to a building element, for example applying render or plaster. The computer-controlled apparatus may be portable and used on site, at the building, or the computer-controlled apparatus may be in a location remote from the building, for example in a factory. The generated instruction data may comprise control data for more than one computer-controlled apparatus.

Alternatively or additionally, the instruction data may comprise instructions for manual fabrication of at least a part of the building system. For example, the instruction data may comprise drawings, parts lists and assembly drawings for the building system, which can be at least partially manually fabricated.

In some examples, the building system comprises a covering for the building element. For example, the building element may comprise a wall of the building, and the building system may comprise one or more of: a thermal insulation, for example external wall insulation panels, a coating, and/or a decorative feature. In one example, the coating comprises render. A decorative feature may be applied to the render, for example a plurality of brick slips can be applied to the render. In this example, the building system comprises render applied to the wall and brick slips applied to the render before it is fully dry to give an appearance of brickwork. In another example, the building system comprises a coating, such as render, plaster or roughcast, and the coating is shaped after application. The coating may be shaped before fully drying by moving the coating into the desired shape or pattern, or the coating may be shaped after drying by cutting away some of the coating to create the desired shape or pattern. In one example, the desired shape or pattern could comprise lines to mimic blockwork.

In some examples, the building element may comprise an ancillary element of the building. For example, the building element may comprise one or more of: a window, a window sill, a fascia, a gutter, a tile, a panel, a fence, a railing, a balcony, and/or a balustrade. In these examples, the building system may comprise a replacement component for at least a part of the building element, for example a replacement gutter pipe. Alternatively, the building system may comprise a covering for the ancillary element, for example a component that covers a window sill.

In accordance with the present disclosure there is also provided apparatus for performing renovation works, the apparatus comprising: electronic scanning apparatus for scanning a building element to generate scan data; and a processor configured to:
a. process the scan data to determine at least one dimension of the building element and an initial property of the building element;
b. configure a building system for the building element to achieve a target property of the building element, the building system being configured according to the at least one dimension of the building element and according to the initial property of the building element; and
c. generate instruction data for fabricating the building system.

In some examples, the apparatus may further comprise computer-controlled apparatus for fabricating the building system in accordance with the instruction data. For example, the apparatus may comprise a computer-controlled apparatus for applying a coating, as described below. In other examples, the apparatus may comprise a computer-controlled cutting machine to cut parts for fabrication of the building system. In some examples, the computer-controlled apparatus may be in a location remote from the building, for example in a factory, to fabricate at least a part of the building system for subsequent installation on the building element. In other examples, the computer-controlled apparatus is portable, and can be used to fabricate at least a part of the building system at the location of the building, for example directly on the building element. Preferably, the electronic scanning apparatus is separate to the computer-controlled apparatus for fabricating the building system. The apparatus may further comprise a control device, and the control device may comprise the processor.

In accordance with the present invention, there is also provided a method for building works, the method comprising:
receiving scan data of an existing building element of an existing building;
processing the scan data to determine at least one dimension of the existing building element and an initial property of the existing building element from the scan data;
configuring one or more new building systems for a new building element having a target property, the one or more new building systems being configured according to the dimension of the existing building element and according to the initial property of the existing building element; and
generating instruction data for fabricating the one or more new building systems.

In this way, a new building element can be configured according to the scan data of the existing building, for example to have an appropriate size and/or to match an appearance of the existing building. In one example, the new building element may be a new wall, for example a wall of an extension, and the size and position of windows in that new wall can be configured to match the size and position of windows in the existing building.

In some examples, the new building element is an extension for the existing building, the extension being configured for connection to the existing building element. For example, the new building element may be a porch configured based on the scan data of a wall of the existing building, including dimensions of the wall, and positions of windows and doors, as well as an appearance of the wall, for example brick colour and arrangement. Advantageously, the porch could be fabricated in an off-site location, for example in a factory, based on the generated instruction data. The fabricated porch can then be installed on the existing building. In another example, the extension for the existing building may be a new terraced house to be built on the end of an existing terraced house. The new terraced house may be configured to match the dimension and appearance of the existing terraced house by configuring the new terraced house based on the scan data of the existing terraced house, in particular the dimension and initial property of the existing terraced house.

In other examples, the new building element may be a separate building to the existing building, for example a garage or outbuilding. In this example, the new building element is not connected to the existing building, but is configured according to the scan data of the existing building, in particular the dimension and the initial property. In one example, the new building element may be a new building, for example a new house. In this example, the separate building may be at least a partial replica of the existing building. For example, scan data of an existing building may be used to configure a new building to have the same size and appearance of the existing building. The new building can then be fabricated, according to the generated instructed data, for construction at any location.

In accordance with the present disclosure there is also provided a method of applying a covering to a building element of a building, for example a wall. The method comprises: receiving scan data of a building element of the building; processing the scan data to determine an initial property of the building element from the scan data; configuring a covering for the building element, the covering comprising a coating configured to achieve a target property of the building element; generating control data to control a computer-controlled apparatus for applying the coating of the covering; and controlling the computer-controlled apparatus for applying the coating in accordance with the control data.

Thus, the covering for the building element, in particular the coating, can be provided by computer-controlled apparatus to achieve the target property based on a scan data of the building element. Therefore, manual labour is reduced or even eliminated, and supervision of application of the coating to achieve the target property of the building element can be reduced or even eliminated, increasing safety for human workers. The building element may be part of an existing building, and the method may be a method of retrofitting the covering to the building element.

In some embodiments, the scan data may be obtained previously, or by a separate method, and therefore in the method according to the present disclosure the scan data is received. Alternatively, the method may further comprise scanning the building element using electronic scanning apparatus to generate the scan data. The electronic scanning apparatus may comprise one or more directional sensors. The one or more directional sensors may include a camera. The one or more directional sensors may include a rangefinder sensor, such as a laser rangefinder sensor. The one or more directional sensors may include a thermal imaging sensor. The camera may be an optical camera. The camera may be an infrared camera. Thus, the scan data can include spatial information about the building element, for example one or more dimensions, obtained by the rangefinder sensor and/or an optical camera. Additionally or alternatively, the scan data may include thermal information on the building element, for example surface temperatures. Additionally or alternatively, the scan data may include visual information about the building element, as captured by an optical camera. The visual information can be processed to determine an appearance, or a material of the building element.

In some examples, the coating is applied to the building element. For example, the building element may comprise a wall and the coating may comprise a render, and the render may be applied to the wall.

In other examples, the covering further comprises insulation for attachment to the building element, and the coating may be applied to the insulation. For example, the insulation may comprise one or more insulation panels. The insulation panels may be attachable directly to the building element, or the insulation may further comprise a frame arranged to support the one or more insulation panels. The coating can be applied to the insulation after attachment of the insulation to the building element, or before attachment of the insulation to the building element. For example, the method may comprise fabrication of at least a part of the covering in a location remote from the building, for example in a factory. In a specific example, the insulation (insulation panels and optional frame) can be fabricated in a factory for subsequent installation on the building element. The coating, for example a render, may be applied at the location remote from the building, for example at the factory, or the coating may be applied after attachment of the insulation to the building element. The method may further comprise installing the covering on the building element. In preferred examples, the coating comprises render or plaster or roughcast.

In some preferred examples, the building element is a wall of the building. In other examples, the building element may be a roof or a floor, and the coating may comprise different materials, for example bitumen, or a spray on polymer coating. The coating may alternatively or additionally comprise paint.

In some examples, configuring the covering comprises selecting a covering from a database according to the initial property of the building element. For example, the initial property may comprise structural information, and the covering can be selected to be compatible with the structural information. The covering may also be configured based on a classification of the building element. In another example, the initial property may comprise an initial appearance, and the covering can be selected according to the initial appearance, for example to match the initial appearance. Alternatively or additionally, configuring the covering may comprise selecting a covering from a database according to the target property of the building element. For example, the target property may be an appearance or a thermal metric, and the covering can be selected to achieve that appearance or thermal metric. The method may further comprise determining the target property from the initial property.

Configuring the covering may additionally or alternatively comprise selecting at least one of a material and a quantity of the material to be used to achieve the target property of the building element based on the scan data. For example, a quantity of material for the coating may be based on one or more dimensions of the building element, or the type of material may be based on an initial structural property of the building element.

The method may further include processing the scan data to determine at least one dimension of the building element. In this example, configuring the covering may comprise configuring the covering according to the dimension, optionally in combination with the initial property and/or the target property.

The method may include determining the target property, for example computing or calculating the target property based on the initial property. Alternatively, the target property may be determined by user input. However, in some examples the target property is not determined. The target property may be assumed. For example, installing insulation to a wall may be assumed to improve a thermal metric of the wall.

The initial property of the building element may include an appearance of the building element. The initial property of the building element may include a thermal metric of the building element. Thus, the covering for the building element can be generated based on the appearance of the building element and/or based on the thermal metric of the building element. Similarly, the computer-controlled apparatus for applying a coating can be controlled to apply a coating to achieve a target property of the building element, which can be the appearance of the building element and/or the thermal metric of the building element, based on the control data.

The appearance may include a shape of the surface of the building element. The appearance may include a colour of the surface of the building element. The appearance may include a texture of the surface of the building element.

It will be appreciated that the scan data may be indicative of a plurality of initial properties of the building element, for example appearance, material, and condition. Similarly, it will be appreciated that the covering may be configured to achieve a plurality of target properties of the building element.

The target property may be configured to match the initial property. The target property of the building element can be substantially the same as, for example exactly the same as, the initial property of the building element. For example, the control data can be to control the computer-controlled apparatus to apply a coating to achieve the same appearance of the building element following application of the covering as the appearance of the building element prior to application of the covering, even if another target property of the building element may be different to another initial property of the building element as a result of applying the covering. For example, a first target property may be the appearance, which can match the initial appearance of the building element, and a second target property may be a thermal metric, which can differ from the initial thermal metric, for example it may be an improved thermal metric.

As will be appreciated from the above, in some examples the target property differs from the initial property. For example, the target property may be an improvement of the initial property.

In some examples, the method further comprises shaping the coating after application of the coating. For example, the coating may be shaped before the coating material has dried. For example, if the coating comprises render, the render can be smoothed or otherwise shaped before the render has dried. In other examples, the coating may be cut after drying in order to shape the render. For example, a router may be used to cut the coating after drying. In one example, the coating is provided with lines that mimic blockwork.

In a further example, the method may further comprise applying a decorative feature to the coating, for example one or more brick slips. The brick slips can be applied to the coating before the coating has dried, to secure the brick slips to the coating.

In preferred examples, the computer-controlled apparatus comprises a material output nozzle and an actuator for moving the material output nozzle, the actuator and the material output nozzle being operable in accordance with the control data. In some examples, the method further comprises performing a location registration operation to determine a location of the computer-controlled apparatus for applying the coating based on the scan data. In this way, the computer-controlled apparatus can determine its position relative to the building element in order to apply the coating.

The method may further comprise scanning the building element after application of the covering to capture further scan data indicative of the target property of the building element. In other words, the further scan data can be generated based on a further scan of the building element subsequent to application of the covering. The method may further comprise determining a quality control characteristic of the covering based on the further scan data. Thus, the performance of the computer-controlled apparatus for applying a coating, and/or the quality of the coating, can be assessed. The quality control characteristic may be additionally based on the scan data indicative of the initial property of the building element.

Viewed from another aspect, the present disclosure provides apparatus for applying a covering to a building element of a building, for example a wall. The apparatus comprises: electronic scanning apparatus configured to scan the building element to generate scan data indicative of an initial property of the building element; and a computer-controlled apparatus for applying a coating of the covering. The apparatus further comprises a processor configured to: receive scan data from the electronic scanning apparatus; process the scan data to determine an initial property of the building element from the scan data; configure a covering for the building element, the covering comprising a coating configured to achieve a target property of the building element; generate control data to control a computer-controlled apparatus for applying the coating of the covering; and control the computer-controlled apparatus for applying the coating in accordance with the control data.

In examples, the electronic scanning apparatus may be separate from the computer-controlled apparatus for applying the coating. The apparatus may further comprise a control device, the control device being separate to the electronic scanning apparatus. The control device may comprise the processor.

The computer-controlled apparatus for applying the coating may comprise a material output nozzle for outputting a coating material, and an actuator to control a position of the material output nozzle.

The computer-controlled apparatus for applying the coating may additionally or alternatively comprise a smoothing tool for smoothing the coating material after application by the material output nozzle. Alternatively or additionally, the computer-controlled apparatus for applying the coating may comprise a shaping tool for shaping the coating.

The computer-controlled apparatus for applying the coating may be configured to apply a coating material, for example render or plaster or roughcast. The coating material can be applied in fluid form, such as in a slurry of mixed sand, cement and water. The coating material can subsequently be moved, smoothed, or shaped before being allowed to dry and set.

After the coating material has dried and set, the coating may be shaped by cutting the coating to remove material. For example, using a router to cut away some of the coating to shape the coating.

As described above, in examples, the covering may be configured according to the initial property of the building element and/or according to the target property of the building element. The target property may comprise an appearance of the building element.

The computer-controlled applicator may comprise a tool and a support structure arranged to support the tool. The support structure may comprise an actuator for operation in accordance with the control data. The control data may be to control the computer-controlled apparatus to apply a coating to achieve the target property of the building element utilising the tool. The actuator may be configured to move the tool through a plurality of positions to apply the coating. It will be understood that the tool may be substantially any tool, for example a material output nozzle, a smoothing tool, or a shaping tool.

In some examples the support structure comprises an articulated arm, and wherein the actuator is configured to be operated in accordance with the control data to move the articulated arm.

In other examples, the support member may comprise: a first member; a second member spaced from and substantially parallel to the first member; and a cross-member connecting the first member to the second member and mounted to both of the first member and the second member for movement in a direction parallel to the first member and the second member. A first actuator may be arranged to move the cross-member in a direction parallel to the first member and the second member. Additionally, the tool may be mounted to the cross-member for movement relative thereto in a longitudinal direction of the cross-member between the first member and the second member. A second actuator may be provided to move the tool in the longitudinal direction of the cross-member. Thus, the support member may be in the form of a gantry.

The apparatus may be configured to move the tool in a direction transverse to the longitudinal direction and the direction parallel to the first member and the second member. Thus, where the first member, the second member and the cross-member are provided substantially parallel to the building element, the tool can be moved towards or away from the building element to apply a covering to the building element to achieve the target property of the building element. In an embodiment, the tool may be configured to move towards or away from the building element by movement relative to the cross-member. In another embodiment, the tool may be configured to move towards or away from the building element by movement of the tool in combination with the cross-member, and optionally also in combination with the first member and the second member. In other words, the whole support member may be configured to move towards or away from the building element.

In a preferred embodiment the apparatus is portable, preferably the computer-controlled apparatus is portable. The computer-controlled apparatus may be configured to apply a coating to a structure for attachment to the building element, the structure and coating together forming the covering. The computer-controlled apparatus may be configured to apply the coating to the structure after attachment of the structure to the building element. Alternatively, the computer-controlled apparatus may be configured to apply the coating to the structure before attachment of the structure to the building element. Thus, the apparatus, in particular the computer-controlled apparatus, may apply the coating to the structure off site, for example in a factory, for later attachment to the building element. The structure may comprise one or more insulation panels and optionally a frame.

It will be understood that the term portable should be taken to mean that the portable apparatus can be provided temporarily in location at the building. Therefore, the portable apparatus can be removed from the building after use.

It will be understood that any data processing, for example processing the scan data to generate the control data or instruction data, can be performed by a device having one or more processors and a memory including instructions to cause the one or more processors to perform the data processing, such as to process the scan data to generate the control data or instruction data. The memory is typically a non-transient computer-readable storage medium.

In the various examples described above, scanning the building element may comprise scanning the building element with a rangefinder sensor, for example a laser rangefinder sensor. The scan data from the rangefinder sensor may comprise a 3D point cloud of the building element. In addition, scanning the building element may comprise capturing images of the building element using an optical camera, in particular still images. Scanning the building element may additionally or alternatively comprise capturing thermal information on the building element using a thermal sensor. The 3D point cloud may be combined with the images and/or the thermal information to form a multi-layered 3D point cloud of the building element. Such a multi-layered 3D point cloud comprises spatial information (from the rangefinder sensor), visual information (from the optical camera) and thermal information (from the thermal sensor). The multi-layered 3D point cloud can be processed to determine the at least one dimension of the building element and the initial property of the building element.

Processing the scan data, in particular the 3D point cloud, to determine the at least one dimension and the initial property may comprise feature recognition based on the spatial information (from the rangefinder sensor), and/or the visual information (from the optical camera), and/or thermal information (from the thermal sensor). Feature recognition may comprise image recognition to classify the building element (e.g. wall, window, roof). Feature recognition may additionally comprise classifying the initial property (e.g. thermal performance of a wall, or appearance of a window). The initial property may be identified by comparing the scan data to a database of building elements with corresponding classification. For example, the material of a wall can be determined by comparing images of the scanned wall to images of other walls stored in a database to determine the material and/or appearance of the scanned wall.

Feature recognition may additionally comprise identifying the position or location of a border of the feature. For example, feature recognition may comprise identifying the position of a window frame or a door frame.

Configuring the building system to achieve the target property may comprise retrieving a target property from a database according to the classification of the building element and the initial property. For example, if a scanned wall has a sub-optimal initial thermal performance then configuring the building system may comprise selecting, from a database, a building system that improves the thermal performance of the wall, for example selecting an external wall insulation building system. The building system is further configured according to the at least one dimension of the building element such that the selected building system is configured for the building element, i.e. sized to fit. For example, the building system may be configured to abut a feature, such as a window frame or a door frame.

The step of generating instruction data for fabricating the building system may comprise processing the scan data, in particular the 3D point cloud, and the configured building system together to generate instruction data.

In preferred examples, the instruction data comprises control data for a computer-controlled apparatus configured to fabricate the building system. The control data may comprise a route or path for movement of a tool of the computer-controlled apparatus. The route can be configured within the 3D point cloud so that the route is spatially matched to the building element. The route may take account of the position of a building element, for example the position of a window frame or a door frame within a wall.

In one example, the computer-controlled apparatus comprises a multi-axis robotic apparatus having a tool that can be moved through a plurality of axes of movement, for example two axes, 3 axes, 4 axes, or 5 axes of movement. An actuator is arranged to move the tool about each of the axes of movement. The route that is configured for fabricating the building system may comprise control data for each actuator over a time period for fabricating the building system, so that during fabrication of the building system the tool is moved according to the control data to fabricate the building system.

In one example, where the building element comprises a wall and the building system comprises a sprayed insulation material, the computer-controlled apparatus comprises an insulation spray nozzle that can be moved through multiple axes of movement in order to move the insulation spray nozzle over the wall to spray insulation material onto the wall and form a covering. Each axis of movement is provided by an actuator. In this example, the control data for the computer-controlled spray apparatus may comprise a spray path comprising control data for controlling the actuators to move the insulation spray nozzle, and spray control data for controlling spraying of the insulation material. Such control data for the computer-controlled spray apparatus can be generated based on the scan data, in particular the 3D point cloud.

### BRIEF DESCRIPTION OF THE DRAWINGS

Embodiments of the invention are further described hereinafter with reference to the accompanying drawings, in which:

FIG. 1 is a flowchart illustrating a method of applying a covering to a building element;

FIG. 2 is a schematic illustration of a building element being scanned by an electronic scanning apparatus;

FIG. 3 is a further schematic illustration of a building element being scanned by an electronic scanning apparatus;

FIG. 4 is another schematic illustration of a building element being scanned by an electronic scanning apparatus;

FIG. 5 is a yet further schematic illustration of a building element being scanned by an electronic scanning apparatus;

FIG. 6 is a schematic illustration of a building element having a coating applied thereto;

FIG. 7 is a further schematic illustration of a building element having coating applied thereto;

FIGS. 8A, 8B and 9 are other schematic illustrations of a building element having a coating applied thereto;

FIG. 10 is another schematic illustration of a building element having a coating applied thereto;

FIG. 11 is a further schematic illustration of a building element having a coating applied thereto;

FIG. 12 is a schematic illustration of a covering for a building element, the covering comprising a plurality of brick slips;

FIGS. 13A to 13E are schematic illustrations of a covering for a building element, the covering having a support structure and insulation panels, and in FIGS. 13B to 13E a coating is applied to the insulation panels;

FIGS. 14A to 14F illustrate an example process of off-site manufacture of a covering for a building and subsequent installation on a building;

FIG. 15 is a flowchart illustrating a method of configuring a building system for a building element;

FIG. 16 is a schematic illustration of a building element being scanned by an electronic scanning apparatus;

FIG. 17 is a flowchart illustrating a method of building works using scan data of an existing building element to configure a new building element.

### DETAILED DESCRIPTION

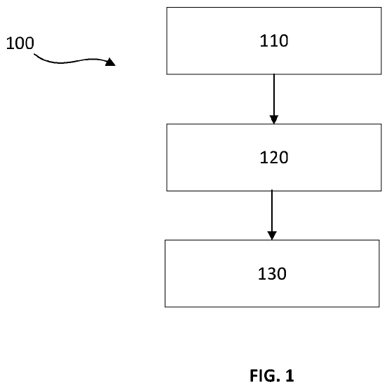

FIG. 1 is a flowchart illustrating a method of applying a covering to a building element, such as a wall. The covering includes a coating. The method 100 is for performing renovation works to a building element to achieve a target property of the building element. Typically, the target property includes a target property of the surface, in particular an appearance property of the building element, though it will be understood that the target property may instead or additionally be other aspects of the building element, such as thermal performance. The target property can be determined based on an initial property of the building element of the building. In this way, the target property of the building element to be achieved can be referred to as a subsequent property, or a resultant property of the building element, as it is the property of the building element subsequent to application of the covering to the building element. In this example, the method 100 comprises a first step 110 of scanning the building element with an electronic scanning apparatus to generate scan data. The scan data is indicative of an initial property of the building element. The method 100 comprises a second step 120 of processing the scan data to configure a covering for the building element, the covering being configured to achieve a target property of the building element. The step 120 is also to generate control data. The control data is to, for example configured to, control a computer-controlled apparatus, for example a robotic device, to apply a coating to the building element to form a covering to achieve the target property of the building element. The method 100 will comprise the second step 120 of processing the scan data even where the scan data has not been generated as part of the first step 110 of the method 100. For example, the scan data may be received from a data storage and the scan data may have been generated not as part of the method. In this case, the method can comprise receiving the scan data, such as from the data storage. The method 100 further comprises a third step 130 of controlling the computer-controlled apparatus in accordance with the control data. The computer-controlled apparatus is controlled in accordance with the control data to apply a coating to the building element to achieve the target property of the building element. In this way, the initial property of the building element, indicated by the scan data, can be used to apply a covering to the building element to achieve the target property, and for example to determine the target property of the building element.

In examples, the electronic scanning apparatus may comprise the sensor apparatus described in the Applicant's co-pending patent application WO2020/079394. Additionally or alternatively, the electronic scanning apparatus may comprise the sensors, processors, and other features as described in any of the Applicant's earlier patent applications, in particular WO2017/220716, WO2016/207627, and/or WO2014188221.

It will be understood that the appearance of a building element means any visual aspect of the building element, including but not limited to the shape, colour and/or texture of the building element. In an example, the computer-controlled apparatus is controlled to carry out an operation to apply a coating to the building element to achieve a target property of the building element to match the initial property of the building element. For example, the computer-controlled apparatus may be controlled to apply a coating to the building element such that the appearance of the building element after application of the coating has substantially the same colour as the appearance of the building element prior to application of the coating. In other words, a person may be unable to see a difference in the colour of the building element when the building element surface had the initial property and when the coating has been applied to achieve the target property of the building element. In another example, the computer-controlled apparatus may be controlled to apply a coating to the building element to achieve the target property of the building element such that the texture of the building element achieved by applying the coating is substantially the same as the texture of the building element prior to applying the coating. In other words, a person may be unable to see a difference in the texture of the building element when the building element had the initial property and when the coating has been applied to the building element to achieve the target property. In yet another example, the computer-controlled apparatus may be controlled to apply a coating to the building element to achieve the target property of the building element such that the 3D shape of the building element achieved by application of the coating is substantially the same as the 3D shape of the building element prior to application of the coating. In other words, a person may be unable to see a difference in the 3D shape of the building element when the building element had the initial property and when the coating has been applied to the building element to achieve the target property. In this way, it can appear that the appearance of the building element achieved by applying the coating aesthetically matches the appearance of the building element prior to application of the coating, in one or more ways. Where the building element is formed to have a certain appearance prior to application of the coating using the computer-controlled apparatus, such as a brickwork appearance (for example because the surface of the building element is formed from brick), the target property of the building element may be configured such that the building element also has a brickwork appearance after application of the coating, based on the received scan data, indicative of the brickwork appearance of the building element prior to application of the coating.

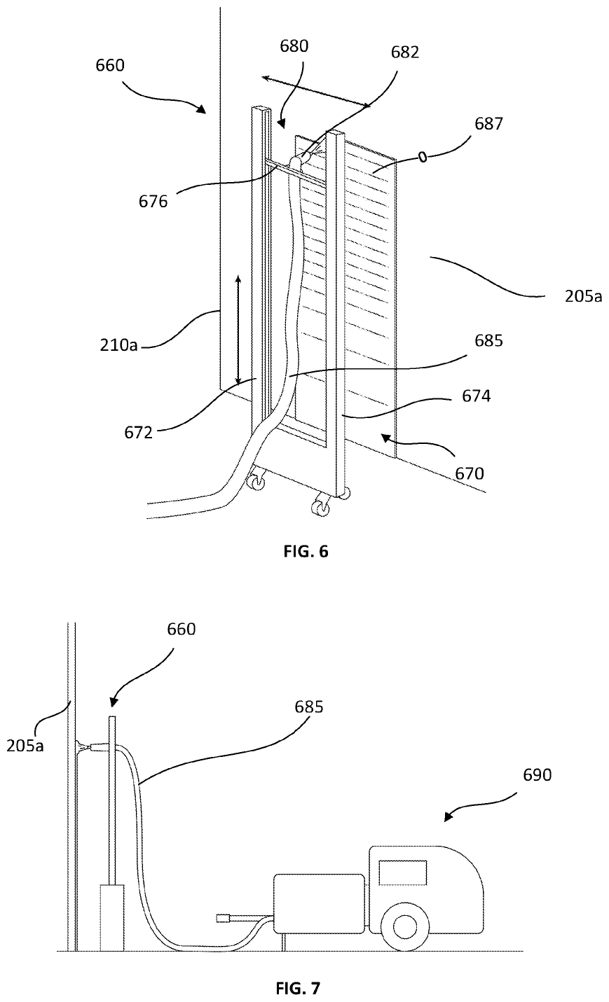

Applying a covering to the building element by the computer-controlled apparatus to achieve the target property of the building element in the third step 130 can include performing any one or more operations to achieve the target property of the building element, as will be discussed further with reference to FIGS. 6 to 11 hereinafter. For example, applying a covering to achieve the target property of the building element by the computer-controlled apparatus can comprise providing a new covering to replace an original covering. The one or more operations may comprise one or more of an insulation installation operation, applying a coating, and a shaping operation, and any other operations. Controlling the computer-controlled apparatus can comprise controlling one or more components of the computer-controlled apparatus. In some examples, a plurality of computer-controlled apparatuses may be used to apply the covering to the building element to achieve the target property of the building element. For example, a first operation may be carried out by a first computer-controlled apparatus and a second operation may be carried out by a second computer-controlled apparatus. The first operation and the second operation together can apply a covering to the building element to achieve the target property of the building element.

The method 100 can comprise determining, for example selecting, a material to be used in the operation to be carried out by the computer-controlled apparatus based on the scan data received in the second step 120. For example, the material can be selected so as to be usable by the computer-controlled apparatus to achieve a desired new appearance of the building element which is determined based on the appearance of the building element prior to application of the covering using the computer-controlled apparatus. The method 100 can additionally or alternatively comprise determining, for example selecting, an amount of material to be used in the operation based on the scan data received in the second step 120. In this way, by determining precisely the amount of material which will be required, wastage can be reduced, as well as the overhead in time, energy and cost in transporting unnecessary material.

The method 100 can comprise additional scanning operations after the covering has been applied to achieve the target property of the building element, for example for quality control purposes. In an example, the method 100 comprises scanning the building element subsequent to the application of the covering to generate further scan data. One or more quality control characteristic, such as a thermal conductivity, a visual appearance or a depth may be determined based on the further scan data. In some examples, a difference characteristic between the resultant property of the building element and the initial property of the building element may be determined based on the further scan data and the previous scan data generated in the first step 110.

In some examples, further scans may be performed as part of applying the covering to the building element to achieve the target property. For example, a higher fidelity scan can be performed at or immediately before the time at which the covering is applied to achieve the target property of the building element to allow a more precise model of the initial property of the building element to be determined.

In further examples, the method 100 can comprise performing a location registration operation. The location registration operation can be performed after the scan of the building element by the electronic scanning apparatus and prior to or as part of application of the coating by the computer-controlled apparatus. The location registration operation will locate the computer-controlled apparatus relative to the building element. Typically, the location registration operation comprises performing a location registration scan of the building element to generate location registration data. The location registration scan is indicative of the location of the computer-controlled apparatus, for example because the location registration scan is performed by the computer-controlled apparatus. The location of the computer-controlled apparatus relative to the building element can be determined based on the location registration data. Typically, the location of the computer-controlled apparatus is determined based on a comparison of the location registration data and the scan data. In this way, the location of the computer-controlled apparatus relative to the building element can be accurately determined. In some examples, markers can be provided one feature of the building which will remain unchanged by application of the covering to the building element, for example, stickers can be placed on the windows of the building. The stickers may provide a location registration target which can be detected in the scan of the building element to generate the scan data and in the location registration scan of the building element to generate the location registration data. In this way, the location of the computer-controlled apparatus can be determined relative to the original building element, based on the detected location of the location registration target in the location registration data, even if the covering has been, or has begun to be, applied to the building element to achieve the target property of the building element.

The method may further comprise performing a location registration operation using the computer-controlled apparatus to determine a location of the computer-controlled apparatus relative to the building element of the building based on the scan data. Thus, the location of the computer-controlled apparatus can be determined based on the previous scan data indicative of the initial property of the building element. The location of the computer-controlled apparatus can be additionally determined based on location data of the computer-controlled apparatus. The location data may be determined based on registration scan data of the computer-controlled apparatus. The registration scan data may be generated based on a registration scan of the building element by the computer-controlled apparatus. The registration scan may be performed prior to application of the covering to the building element to achieve the target property of the building element. The registration scan data may be aligned with the scan data to determine the location of the computer-controlled apparatus relative to the building element. Thus, accurate location information for the computer-controlled apparatus can be determined.

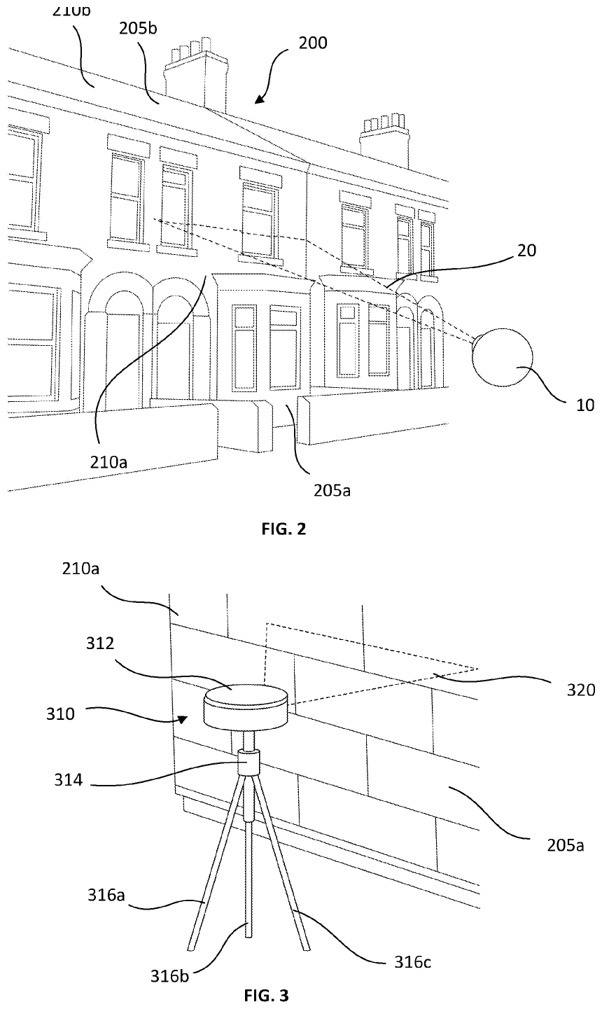

In the example method of FIG. 1, illustrated further in FIGS. 2 to 14F, the building element is a wall, and the building system is a covering that is applied to the wall. The covering includes a coating.

FIG. 2 is a schematic illustration of a building element of a building 200 being scanned by an electronic scanning apparatus, in particular a wall being scanned. The building 200 comprises a plurality of walls 205a, 205b, each of which is a building element of the building. In this view, the building 200 can be seen to comprise a first wall 205a, which is the front of the building 200. A further wall 205b in the form of a roof panel 205b is provided connected to an upper end of the first wall 205a. Each of the walls 205a, 205b of the building defines a surface 210a, 210b having an initial property in the form of an initial appearance. For example, the first wall surface 210a has a brickwork initial appearance (not shown in FIG. 2), including the location and dimensions of one or more windows. The roof panel surface 210b can have a tiled roof initial appearance (not shown).

Also shown in FIG. 2 is the electronic scanning apparatus 10 which is configured to scan in a scanning beam 20. In this example, the scanning beam 20 encompasses the first wall 205a and therefore detects one or more initial properties, including an appearance, of the first wall 205a prior to application of a covering to the first wall 205a to achieve a target property of the first wall 205a. It will be understood that the electronic scanning apparatus 10 can be configured to scan multiple building elements of the building 200. In this way, it will be understood that the electronic scanning apparatus 10 generates scan data by scanning the first wall 205a of the building 200. The scan data is indicative of the one or more initial properties of the first wall 205a of the building 200, prior to a covering being applied to the first wall 205a to achieve a target property of the first wall 205a.

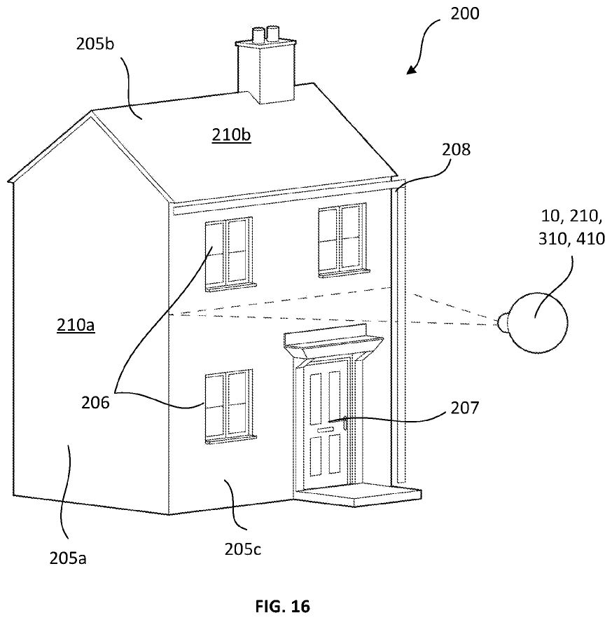

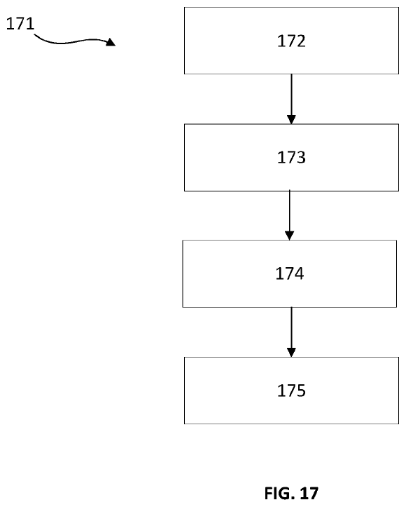

Thus, in this example, the electronic scanning apparatus 10 is configured to scan a wall of the building 200. However, it will be understood that in other examples, the electronic scanning apparatus 10 can be configured to scan another building element of the building 200, such as windows or doors, as explained hereinafter with reference to FIGS. 15 and 16.

The electronic scanning apparatus 10 typically comprises one or more directional sensors, for example a plurality of directional sensors, including at least an optical camera and a rangefinder sensor in order to generate a model of a building element to define an original appearance of the building element. In examples, the electronic scanning apparatus 10 can also comprise a thermal sensor. The scan data generated by the electronic scanning apparatus 10 may comprise a 3D point cloud generated using spatial information from the rangefinder sensor. Other scan data, or example optical images and thermal information, may be layered onto the 3D point cloud to provide a multi-layered 3D point cloud model of the building element.

The electronic scanning apparatus 10 can be moveable, for example on wheels or tracks, or as an airborne vehicle, such as a drone. In some examples, the electronic scanning apparatus 10 can be moved between positions by a human operator.

Although the scanning beam 20 is shown as a flat, substantially horizontal scanning beam, it will be understood that other shapes of beam may be provided. The scanning beam may be in a direction other than substantially horizontal, for example substantially vertical. In some examples, the scanning beam can be a region rather than a line, for example a rectangular region or a substantially circular region. In other words, the electronic scanning apparatus 10 can be configured to scan in a region including one or more building elements of the building 200. The scanning apparatus 10 may be moved in a scanning motion, for example by moving the scanning apparatus 10 in a linear or rotational manner, to move the scanning beam 20 across the surface being scanned.

FIG. 3 is a further schematic illustration of a building element of a building being scanned by an electronic scanning apparatus, in this example a first wall 205a having a first wall surface 210a. It can be seen in FIG. 3 that the first wall surface 210a has a brickwork initial appearance. As in FIG. 3, an electronic scanning apparatus 310 is provided. The electronic scanning apparatus 310 shown in FIG. 3 may be substantially similar to the electronic scanning apparatus 10 shown in FIG. 2, apart from the hereinafter noted differences. The electronic scanning apparatus 310 comprises a sensor head 312 comprising one or more directional sensors to scan in a sensor beam 320. The electronic scanning apparatus 310 further comprises a tripod support 314 supporting the sensor head 312 off a ground surface. The tripod support 314 comprises three legs 316a, 316b, 316c which are supported on the ground surface to support the sensor head 312 off the ground surface. By rotation of the sensor head 312, the one or more sensors of the sensor head 312 can detect different regions on the first wall 205a, thereby generating scan data indicative of the appearance of the first wall 205a prior to application of a covering to the first wall 205a to achieve a target property of the first wall 205a.

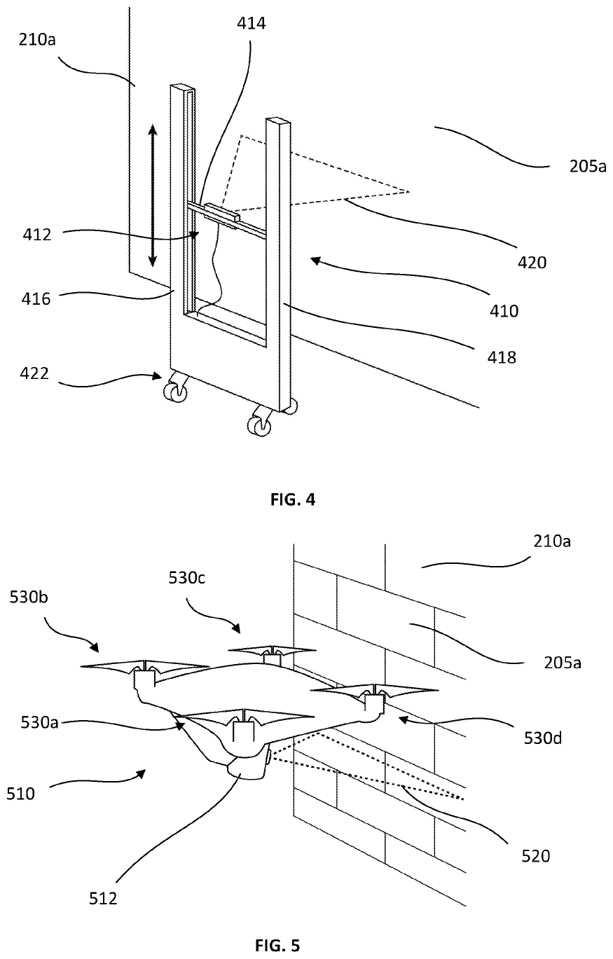

FIG. 4 is another schematic illustration of a building element of a building, in this example a wall 205a, being scanned by an electronic scanning apparatus 410. As can be seen, a different electronic scanning apparatus 410 is provided to the electronic scanning apparatus 310 shown in FIG. 3. Nevertheless, the electronic scanning apparatus 410 shown in FIG. 4 is substantially similar to the electronic scanning apparatus's shown in FIGS. 2 and 3, apart from the hereinafter noted differences. As in FIG. 3, the electronic scanning apparatus 410 is configured to scan the wall 205a. The electronic scanning apparatus 410 comprises a sensor head 412 configured to be receptive to wall features within a scanning beam 420 to scan the wall surface 210a to generate scan data indicative of the appearance of the wall 205a prior to any covering being applied to the wall 205a to achieve one or more target properties of the wall 205a. The sensor head 412 is provided on a cross member 414. The cross-member connects a first vertical member 416 with a second vertical member 418. The first vertical member 416 is substantially parallel to the second vertical member 418. The cross member 414 is moveable relative to the first vertical member 416 and the second vertical member 418 in a longitudinal direction of the first vertical member 416 and the second vertical member 418. The electronic scanning apparatus 410 is supported off the ground surface by a moveable stand 422, in the form of a plurality of wheels, such as caster wheels. A height position of the sensor head 412 can be controlled by movement of the cross member 414 up or down along the first vertical member 416 and the second vertical member 418. A horizontal position of the sensor head 412 can be controlled by movement of the sensor head 412 along the cross member 414, in a substantially horizontal position. Thus, a relatively large region of the wall surface 210a can be scanned by the electronic scanning apparatus 410 by movement of the sensor head 412 without movement of the electronic scanning apparatus 410 on the ground surface. It will be understood that an alternative arrangement for the electronic scanning apparatus may use two horizontal members having a substantially vertical cross-member connected therebetween, where movement of the sensor head 412 in a horizontal direction can be provided by movement of the cross-member in a longitudinal direction of the two horizontal members. Similarly, vertical movement of the sensor head 412 can be provided by movement of the sensor head 412 on the substantially vertical cross-member.

As can be seen, the wall 205a in FIG. 4 may have a different initial appearance to the wall shown in FIG. 3. For example, the wall 205a in FIG. 4 may have a rendered appearance, or any other appearance different to the brickwork appearance shown in FIG. 3. Indeed, it is also possible that the initial appearance of the walls in FIGS. 3 and 4 are the same. That is, the electronic scanning apparatus 410 can be used on substantially any initial appearance of a wall.

FIG. 5 is a yet further schematic illustration of a wall 205a of a building being scanned by an electronic scanning apparatus. In this example, the electronic scanning apparatus 510 is in the form of an airborne scanning apparatus 510, such as a drone 510. The airborne scanning apparatus 510 comprises a sensor head 512 having one or more sensors for scanning the wall 205a. The sensor head 512 is configured to scan in a scanning beam 520. As will be appreciated, the airborne scanning apparatus 510 can be moved substantially anywhere over an outside, or within the building to scan the walls and other building elements of the building. The resulting scan data will be indicative of an initial appearance of the surfaces. In this example, the airborne scanning apparatus 510 comprises four lift engines, in the form of propellers 530a, 530b, 530c, 530d controllable to manoeuvre the airborne scanning apparatus 510 relative to the surface 210a.

It will be understood that any of the electronic scanning apparatus disclosed herein may additionally or instead be used to scan a building element of the building whilst a covering is being applied to the building element, or during other construction or renovation work, to achieve a target property of the building element. Alternatively, the electronic scanning apparatus can be used to scan the building element subsequent to the building element having a covering applied to it, or after other construction or renovation works, to achieve a target property of the building element.

It will be understood that each of the electronic scanning apparatus disclosed herein will typically generate scan data indicative of an initial property of the building element as a result of scanning the building element. In some examples, the electronic scanning apparatus may also process the scan data to generate control data. The control data may be to control a computer-controller apparatus, for example a robotic device, to apply a covering to the building element to achieve a target property of the building element, as per the method illustrated in FIG. 1. In some examples, the target property of the building element, such the appearance of the building element, can be determined based on the scan data. In other examples, the control data can be generated on a further device, in data communication with the electronic scanning apparatus, such as the computer-controller apparatus described hereinafter.

FIG. 6 is a schematic illustration of a building element, in this example a wall 205a, having a coating applied thereto to achieve a target property of the wall 205a. A computer-controlled apparatus, in this example a robotic device 660, is configured to apply a coating to the surface 210a of the wall 205a to achieve a target property of the wall 205a. In this example, the coating comprises render. The robotic device 660 comprises a support frame 670, comprising a first vertical member 672, a second vertical member 674 and a cross-member 676 connecting the first vertical member 672 to the second vertical member 674. A tool head 680 is supported by the support frame 670. The tool head 680 comprises an output nozzle 682 for outputting coating material, for example build material such as render material therefrom onto the wall surface 210a. The tool head 680 is connected to a source of operation material via a supply hose 685. The tool head 680 can be moved by movement of the members of the support frame 670. For example, the tool head 680 can be moved horizontally by horizontal movement of the tool head 680 along the cross-member 676. The tool head 680 can be moved vertically by vertical movement of the cross-member 676 along both the first vertical member 672 and the second vertical member 674. In this way, the robotic device 660 can apply a coating to the surface 210a of the wall 205a to achieve a target property, for example including a target shape, of the surface 210a of the wall 205a. In some examples, it may be that the robotic device 660 is substantially similar to the electronic scanning apparatus 410 shown in FIG. 4, but having the sensor head 412 of the electronic scanning apparatus 410 changed for the tool head 680 of the robotic device 660. In other examples, the electronic scanning apparatus 410 can be a separate device to the robotic device 660.

In this example, the robotic device 660 is configured to apply a coating to the wall 205a by carrying out a render application operation on the wall surface 210a. The tool head 680 progresses over the wall surface 210a, outputting render material 687 onto the wall surface 210a to apply a coating to the wall 205a to form a covering to achieve a target property. In this way, a new surface is provided to replace the wall surface 210a, by covering the wall surface 210a. In this example, the tool head 680 progresses upwards over the wall surface 210a. It will be understood that, in some examples, further operations may be required to achieve the target property of the wall 205a.

The robotic device 660 is controlled in accordance with control data. Typically, the control data is generated by processing the scan data described hereinbefore, indicative of an initial property of the building element, in this example the wall 205a. The control data is to control the robotic device 660 to apply a coating to the wall 205a to achieve the target property of the wall 205a. Thus, it can be seen that the control data is determined in dependence on the scan data. In some examples, the target property of the wall 205a can be determined in dependence on the initial property of the wall 205a indicated by the scan data. It will be understood that the control data can be received by the robotic device from a further device, such as the electronic scanning apparatus, in data communication with the robotic device. Alternatively, the control data can be generated by the robotic device based on the scan data, which is received by the robotic device from the further device, for example the electronic scanning apparatus, in data communication therewith.

FIG. 7 is a further schematic illustration of a covering being applied to a building element, particularly a render coating applied to a wall 205a, to achieve a target property of the building element. The computer-controlled apparatus, for example a robotic device 660, can be the same robotic device 660 described in relation to FIG. 6 hereinbefore. The supply hose 685 is connected to a source of operation material 690, such as a source of render material 690. In this example, the source of render material 690 is a portable render mixing apparatus for mixing render for supply to the tool head 680 via the supply hose 685. It will be understood that other sources of render material 690 can be used, for example ready-mixed render material.

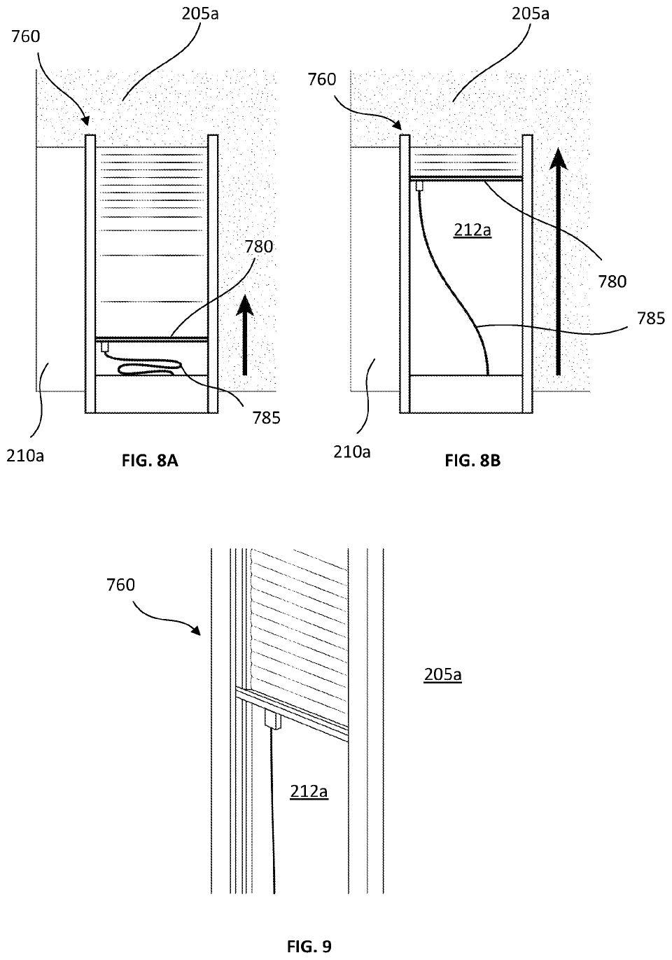

FIGS. 8A, 8B and 9 are other schematic illustrations of a building element having a coating applied to achieve a target property of the building element, in these examples the building element is a wall 205a. In this example, the computer-controlled apparatus, specifically the robotic device 760 of FIGS. 8A to 9, is substantially identical in form to the robotic device 660 shown in FIGS. 6 and 7, apart from that the tool head 680 and supply hose 685 have been replaced by a smoothing tool 780 (best illustrated in FIG. 9), and a control connection 785 in the form of a control cable 785. The smoothing tool 780 is for use on a surface 210a of the wall 205a after application of render thereto, as described with reference to FIGS. 6 and 7 hereinbefore, and before the render has set. The smoothing tool 780 is moved across the applied render material to provide a smooth, substantially flat surface shape to achieve the target property, including the target surface shape, of the wall 205a. In this example, the tool head 680 is replaced by the smoothing tool 780 which is configured to contact against the unset render material. The smoothing tool 780 in this example is arranged to progress upwards over the render material, providing a smooth surface 212a to cover the wall surface 210a. In this example, the smoothing tool 780 is provided with a substantially straight surface for smoothing the applied render material. By controlling a distance between the smoothing tool 780 and the underlying original surface of the wall, a thickness of the render material can be controlled.

In some examples, the robotic device 760 of FIGS. 8A to 9 may completely replace the robotic device 660 shown in FIGS. 6 and 7 in the render application operation described herein.

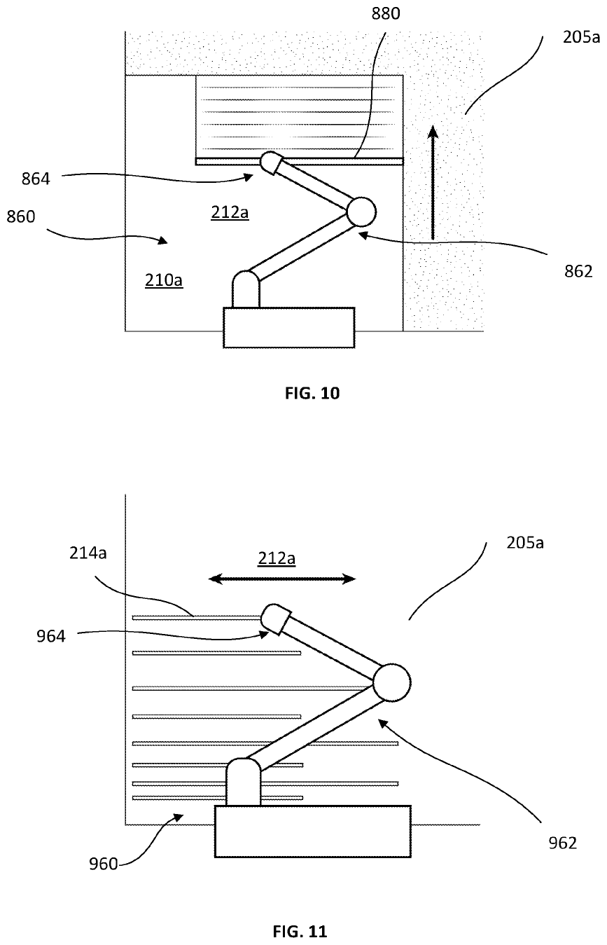

FIG. 10 is another schematic illustration of a wall surface 210a of a wall 205a having a coating applied thereto to achieve a target property of the wall 205a. The computer-controlled apparatus, specifically the robotic device 860 shown in FIG. 10, is an alternative robotic device to that shown in FIGS. 8A to 9 for carrying out the operation of smoothing the render applied to the building element. As can be seen, the robotic device 860 comprises a robotic arm 862. The robotic arm 862 supports the smoothing tool 880 at a working end 864 thereof. In this example, the robotic arm 862 is an articulated arm comprising a plurality of actuators, for example motors (not shown), drivable to move one or more components of the robotic arm 860 and configured to provide the working end 864 of the robotic arm 860 in any of a plurality of positions in a region surrounding the robotic arm 860. In this example, the robotic arm 860 is controlled to maintain the smoothing tool in a substantially constant attitude relative to the wall surface 210a, for example substantially horizontal.

FIG. 11 is a yet further schematic illustration of a coating being applied to a building element, in this example a wall 205a, to achieve a target property of the wall 205a. A computer-controlled apparatus, for example a robotic device 960, is used to apply the coating. The robotic device 960 in this example is substantially similar to the robotic device 860 described in relation to FIG. 10 hereinbefore, including a robotic arm 962 having a working end 964, apart from the hereinafter described differences. At the working end 964, there is a shaping tool, for example a routing tool (not shown) for defining a target 3D shape, such as a 3D depression 214a, in the previously smoothed render surface 212a applied to the wall surface 210a. In this way, it can be seen that a target appearance, including one or more depressions 214a, is achieved on the surface, and is arranged to replace the underlying surface. The robotic device 960 is controlled such that the appearance of the wall 205a after the coating has been applied to the wall is based on the appearance of the wall 205a prior to application of the coating to achieve the target property, as defined by the scan data, for example as a result of scanning using the electronic scanning apparatus. In this example, the target shape of the surface 210a after the coating has been applied to provide the target property is based on the shape of the surface prior to the coating being applied.

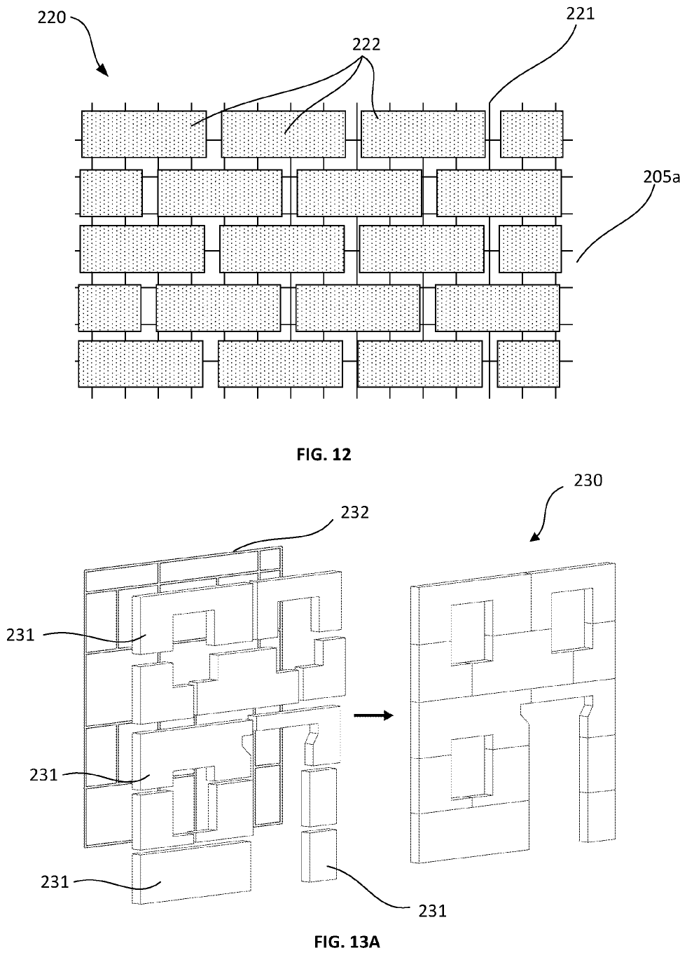

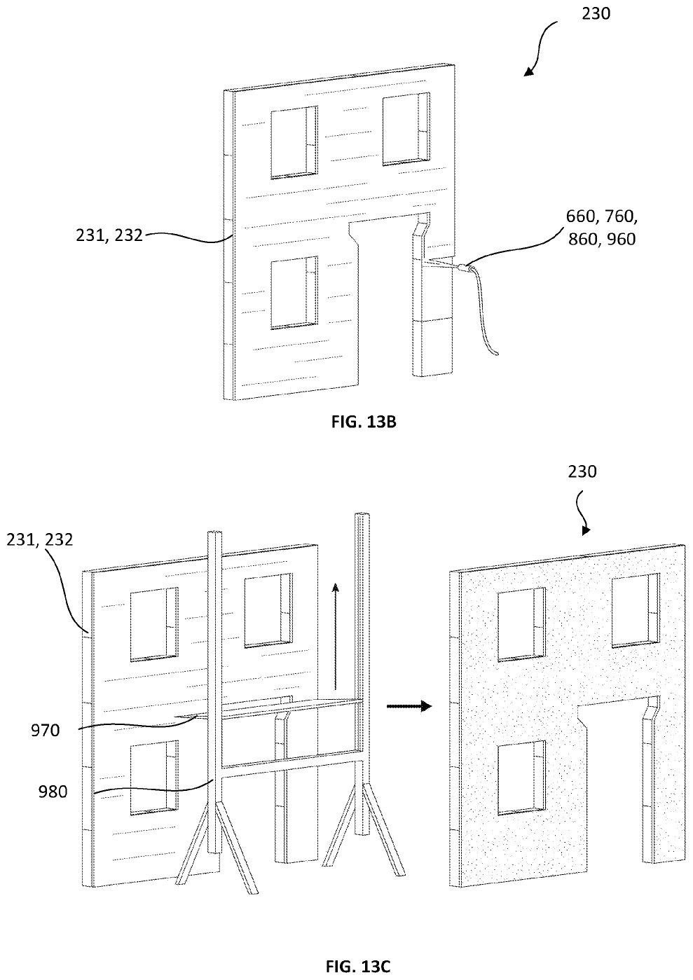

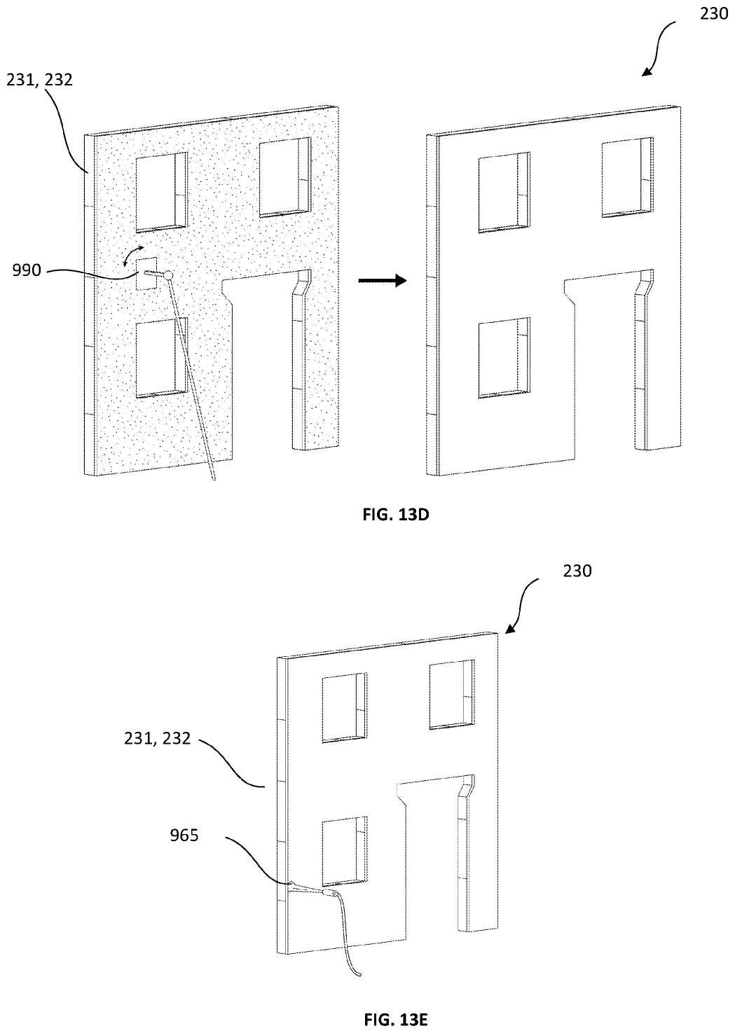

It will be understood that although the examples of FIGS. 6 to 11 describe the application of a coating to the wall 205a, including applying, smoothing and patterning render, it will be appreciated that other operations for applying a covering are also possible, using the principles, methods, apparatus and devices described herein. For example, as explained further with reference to FIG. 12, the covering may comprise a decorative element, or as per the examples of FIGS. 13A to 13E, the covering can comprise insulation. It will be further appreciated that application of the covering can also comprise further operations, for example sprayed insulation application, brick-laying, and/or tiling.

FIG. 12 shows a brick slip covering 220 for a building element, in this example wall 205a. The brick slip covering 220 comprises a mesh 221 having a plurality of brick slips 222 attached to the mesh 221. The brick slips 222 are thin elements that resemble bricks from the front. The mesh 221 supports the plurality of brick slips 222 in an arrangement that mimics bricks in a real wall. Therefore, by attaching the brick slip covering 220 to a building element, for example wall 205a, the brick slips 222 can create an appearance of a brick wall. The brick slip covering 220 can be pressed onto a coating of not-dry render already applied to the wall 205a to secure the brick slip covering 220 to the wall 205a. Gaps between the brick slips 222 can be pointed, with cement, to give a complete appearance.

In this example, the underlying coating may be applied by the apparatus of any of FIGS. 6 to 10, and brick slip covering 220 can be applied manually or by further computer-controlled apparatus.

In an alternative example the individual brick slips 222 can be individually applied to render coating to secure them to the wall 205a, without use a mesh to hold them together.

In alternative examples the brick slips 222 of the brick slip covering 220 shown in FIG. 12 may be replaced by other elements, for example tiles or panels, to create different appearances on the wall 220.

FIGS. 13A to 13 E illustrate a further example of applying a covering 230 to a building element, in particular a wall 205a of a building 200 (see FIG. 2). In this example, the covering 230 comprises insulation, in this example insulation panels 231. As shown in FIG. 13A, the insulation panels 231 may be supported by a support frame 232. The insulation panels 231 and frame 232 are shaped to accommodate features of the wall 205a, such as a door and windows, as illustrated. The sizes and shape of the insulation panels 231 are configured according to the dimensions of the wall 205a as determined in the scan data obtained by the scanning apparatus 10 described with reference to FIGS. 2 to 5. The covering 230 can be installed on a wall 205a, for example by attaching the insulation panels 231 and/or the support frame 232 to the wall 205a of the building 200.

The insulation panels 231 form a covering that may be applied to the wall 205a to achieve a target property of the wall 205a, for example improved thermal efficiency.

In some examples, the insulation panels 231 are applied or attached directly to the wall 205a, without the frame 232 illustrated in FIG. 13A. For example, fixings can be used to attach the insulation panels 231 to the wall 205a, or the insulation panels 231 may have an adhesive for application to the wall 205a.

After application of the insulation panels 231 to the wall 205a the insulation panels 231 and optional frame 232 can be provided with a coating, for example a render coating, as illustrated in FIGS. 13B to 13E. The render can provide a smooth and protective coating for the insulation panels 231, and can be painted or otherwise decorated for appearance. The render may be applied using the apparatus of any of FIGS. 6 to 11, and may optionally include the brick slips of FIG. 12. The render may be applied to form a coating such that the covering 230 achieves a target property of the building element 205a, for example an appearance.

FIG. 13B shows application of a coating to the insulation panels 231 by spraying using spray apparatus, for example the robotic apparatus 660, 760, 860, 960 of any of FIGS. 6 to 11. Preferably, the coating is a render coating. As shown in FIG. 13C, the render may be smoothed over with a smoothing tool 970, which may be part of the robotic device 660, 760, 860, 960 of any of FIGS. 6 to 11. In this example, the smoothing tool 970 is mounted to a gantry 980 for moving the smoothing tool 970 over the surface of the render coating.

FIG. 13D shows an example of applying a finish to the render coating that has been applied to the insulation panels 231 to form the covering 230. A finishing tool 990 may be used to create the finish, which may be for example a roughened surface. The finishing tool 990 may be part of the robotic apparatus 660, 760, 860, 960 of any of FIGS. 6 to 11. In some examples, the finishing tool 990 may be adapted to cut away parts of the render to provide a surface finish, such as brick lines, as described with reference to FIG. 11.

FIG. 13E shows application of sprayed surface finish, for example paint, that is applied by spray apparatus 965. The spraying apparatus 965 may be a part of the robotic apparatus 660, 760, 860, 960 of any of FIGS. 6 to 11.

In alternative examples, the insulation panels 231 can be provided with an outer cover in the form of cover panels, for example metal or ceramic panels, that cover and protect the insulation. The cover panels can be applied to form an outer cover that achieves a target property of the building element 205a, for example an appearance or weather-proofing.

In some examples, fabrication of the covering 230, including the frame 232 and insulation panels 231, can be performed off site, that is, in a location remote from the building element 205a. The fabrication can be performed in a factory. In one example, a computer-controlled apparatus in a factory at least partly fabricates the frame 232 and the insulation panels 231 to form a covering 230 that can then be transported to the building element 205a for attachment to form a covering 230 on the building element 205a. Specifically, computer-controlled apparatus in a factory may cut frame members and insulation panels according to control data, and these frame members and insulation panels can be assembled to form the covering 230. A computer-controlled apparatus may also perform assembly tasks to assemble the frame members and insulation panels 231.

In some examples, a coating is applied to the covering 230, for example a render coating. The coating can be applied to the insulation panels 231 and frame 232 at the off site location, i.e. at the factory. The render can be applied by a computer-controlled apparatus operated in accordance with the control data, for example any of the robotic apparatus 660, 760, 860, 960 illustrated in FIGS. 6 to 11 and 13B to 13E can be used in the factory to apply a coating. In this way, a complete covering 230, having insulation panels 231, frame 232, and coating, can be fabricated remotely from the building element 205a for later installation by attachment, thereby avoiding many of the disadvantages of on site fabrication.

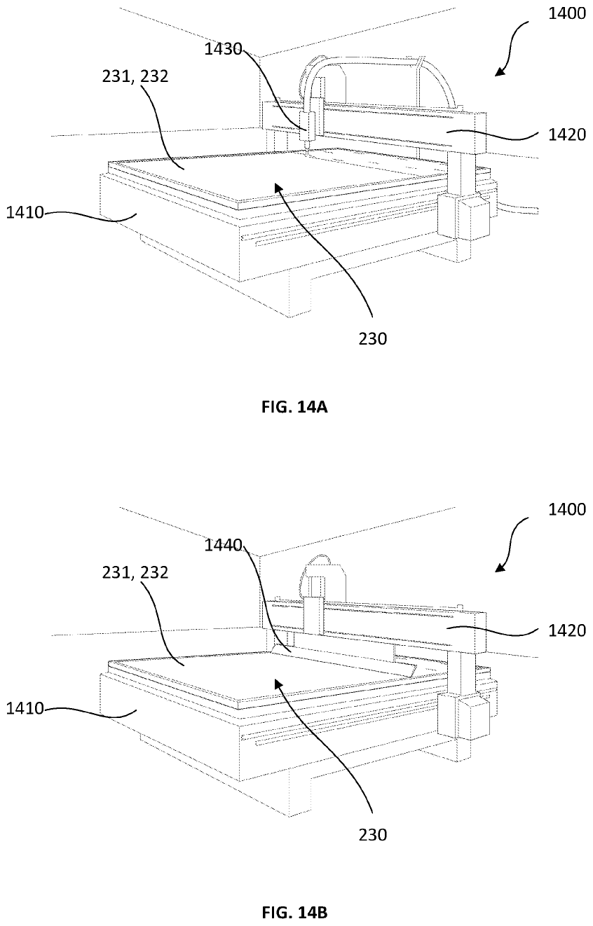

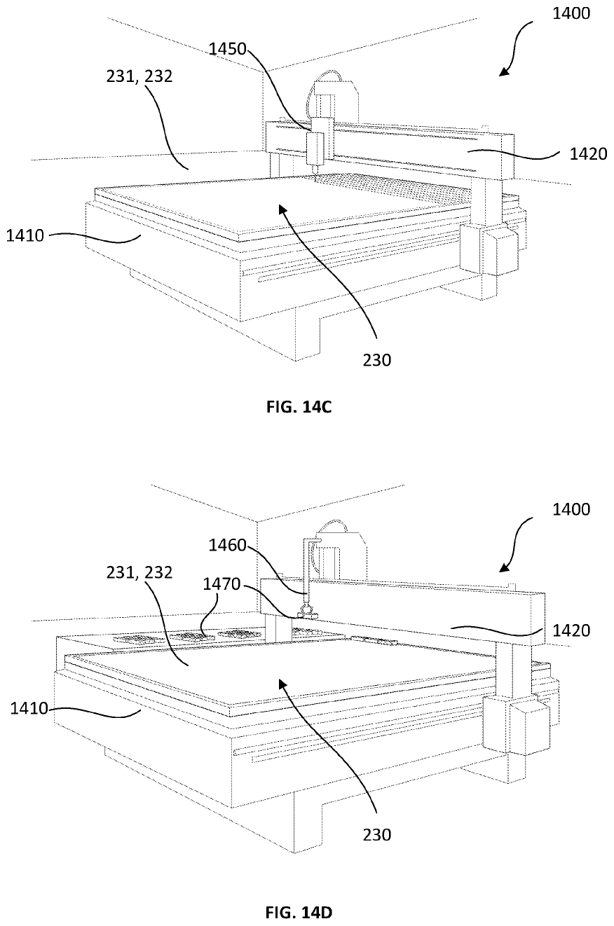

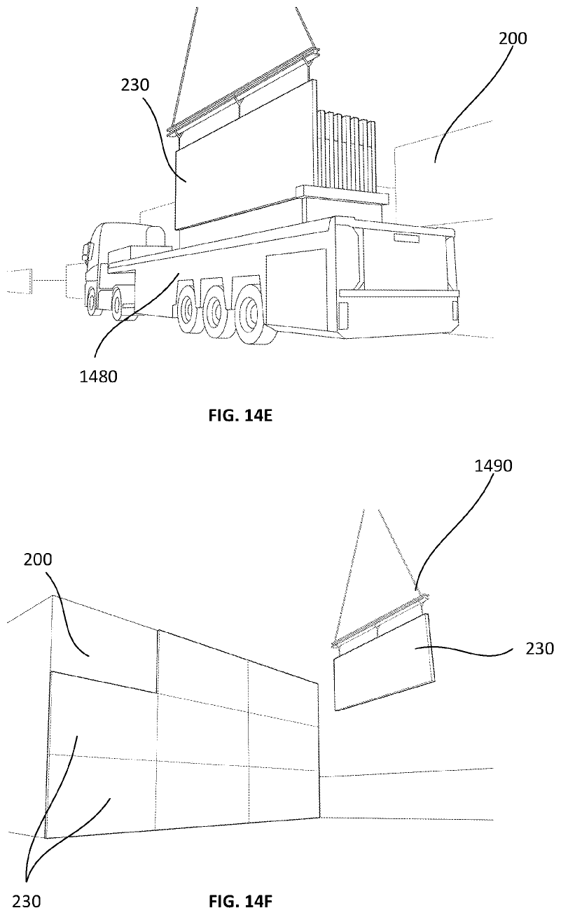

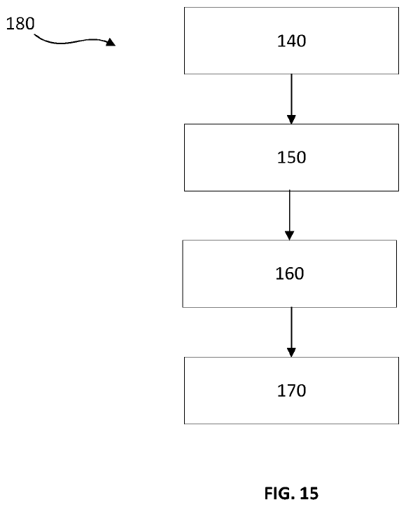

FIGS. 14A to 14F illustrate such an off-site method. In particular, FIGS. 14A to 14F illustrate apparatus that manufactures a covering 230 for a building 200, in particular a wall 205a of a building 200, in an off-site location such as a factory, for subsequent installation on the building 200.

FIG. 14A shows apparatus 1400 for manufacturing a covering 230 for a building 200 in an off-site location. The apparatus 1400 includes a machine bed 1410 which supports the covering 230 during manufacture. In particular, an insulation panel 231 or a plurality of insulation panels 231 and optionally also a supporting frame 232 are positioned on the machine bed 1410. A gantry 1420 supports and moves a material application tool 1430 over the insulation panels 231 on the machine bed 1410, to apply material to the insulation panels 231. In the example illustrated, the material application tool 1430 is a spray nozzle for applying render to the insulation panels 231 to form a coating on the insulation panels 231. The gantry 1420 can move the material application tool 1430 in at least two directions, specifically the axes parallel with the plane of the machine bed 1410, for applying material to the entire surface of the insulation panels 231. In preferred examples, the gantry 1420 can also move the material application tool 1430 in a third direction, perpendicular to the plane of the machine bed 1410, in particular vertically, to accommodate different thicknesses of insulation panels 231, different thicknesses of applied material, and to allow the material application tool 1430 to create surface textures by applying material in different thickness across the insulation panels 231.

FIG. 14B illustrates the same apparatus 1400 as FIG. 14A, but the material application tool 1430 has been replaced with a smoothening tool 1440. The gantry 1420 supports and moves the smoothening tool 1440 across the applied material to create a smooth surface. The apparatus 1400 may be adapted by replacing the material application tool 1430 with the smoothening tool 1440, or separate apparatuses 1400 may be provided, one with the material application tool 1430 and one with the smoothening tool 1440.

FIGS. 14C and 14D illustrate example apparatus 1440 for applying a finish to the material applied and optionally smoothed by the apparatus of FIGS. 14A and 14B. In particular, the apparatus 1400 of FIGS. 14C and 14D also comprises a machine bed 1410 to support the covering 230 as it is manufactured, and a gantry 1420 for supporting a moving a tool for processing the covering 230.

In the example of FIG. 14C, the apparatus 1400 comprises an cutting tool, for example an engraving tool 1450 such as a router, for cutting the material that has been applied to the insulation panels 231. The engraving tool 1450 can be used to cut the material to provide a surface pattern, for example brick lines.

In the example of FIG. 14D, the apparatus 1400 includes a pick-and-place arm 1460 adapted to pick brick slips 1470 and position them on the material that has been applied to the covering 230 to provide a brick effect to the covering 230.

It will appreciated that the apparatus 1400 described with reference to FIGS. 14A to 14D is computer-controlled and can be operated according to control data generated by processing scan data of the building element, as described. In this way, based on scan data obtained of a building 200, a covering 230 can be configured and then fabricated off-site for attachment to the building 200.

FIGS. 14E and 14F illustrate transport of the manufactured coverings 230 from the off-site location to the building 200 for installation. FIG. 14E shows the coverings 230 being transported to the building 200 by a vehicle, specifically a truck 1480. FIG. 14F shows the coverings 230 being lifted into position on the building 200 for installation, preferably using a crane 1490. In an alternative example the frame 232 and insulation panels 231 can be cut and installed on site to fabricate the covering 230. Optionally, the frame 232 and insulation panels 231 are assembled as they are attached to the building element 205a. The coating, for example the render coating, can then be applied on site, for example using the computer-controlled apparatus 660, 760, 860, 960 of any of FIGS. 6 to 11, as shown in FIGS. 13B to 13E.

In an alternative example, a combination of off site and on site fabrication is employed, for example by fabricating the frame 232 and insulation panels 231 in a factory, attaching the frame 232 and insulation panels 231 to the building element 205a, and then applying a coating, for example render coating, on site to complete the covering 230 for the building element 205a.

The examples of FIGS. 1 to 14F relate to applying a covering to a building element, specifically a wall 205a, specifically an external wall of a building 200. However, it will be appreciated that the method and apparatus described with reference to FIGS. 1 to 13E can be used to apply a covering to a different building element, for example an internal wall, a pitched roof, a flat roof, a floor, a chimney stack, stairs, or other building elements. Furthermore, it will be appreciated that the covering is a building system that is applied to a building element, and FIGS. 15 and 16 describe alternative examples in which scan data is used to configure different building systems for different building elements, for example a window, a door, or a gutter.

FIG. 15 illustrates a method for renovation works on a building 180 having a plurality of building elements, for example a plurality of walls. The method includes a first step 140 of scanning the building element with an electronic scanning apparatus to generate scan data. The first step 140 may comprise use of the apparatus of any of FIGS. 2 to 5. The method 180 comprises a second step 150 of processing the scan data to determine at least one dimension of the building element, and to determine an initial property of the building element. A third step 160 of the method 180 comprises configuring a building system for the building element. The third step 160 comprises configuring the building system to achieve a target property of the building element. The building system is configured according to the at least one dimension of the building element and according to the initial property of the building element. A fourth step 170 of the method 180 comprises generating instruction data for fabricating the building system. The instruction data is to, for example configured to, control a computer-controlled apparatus, for example a robotic device, to fabricate a building system for the building element.

The method 180 will comprise the second step 150 and the third step 160 even when the scan data has not been generated as part of the first step 140 of the method 180. For example, the scan data may be received from a data storage and the scan data may have been generated not as part of the method. In this case, the method can comprise receiving the scan data, such as from the data storage.

In this way, a building system for the building element, for example a covering or a replacement component, can be configured according to the determined dimension and according to the initial property of the building element, indicated by the scan data.

In some preferred examples of the method 180, the building element is a wall of the building, and the wall comprises a surface. In this case, the building system may comprise a coating, for example a render, for application to the wall to form a covering, similarly to the examples described with reference to FIGS. 1 to 13E. In other examples, the building element may be a roof or a floor, and the building system can comprise different materials, for example plaster, insulation, paint, paneling, bricks, brick slips, and/or tiles. In these examples, the building system may comprise a covering, and covering optionally includes a coating.

In other examples of the method 180, the building element is an ancillary component of the building, for example a window, a window frame, a window sill, a fascia, a gutter, a tile, a panel, a fence, a railing, or a balustrade. In these examples, the building system may be a covering, or it may alternatively be a replacement component for at least a part of the ancillary element.

The step 150 of determining at least one dimension of the building element comprises determining from the scan data one or more of a height, a width, and/or a depth of the building element or a part of the building element. The step 150 of determining an initial property of the building element comprises determining from the scan data a non-dimensional property of the building element, for example a thermal metric of the building element, an appearance of the building element, a material of the building element, a condition of the building element, a structure of the building element, or a moisture content of the building element. The step 150 of determining a non-dimensional property of the building element may comprise comparing the scan data, or a part of the scan data, to a database in order to classify and recognise the non-dimensional property, for example appearance.

According to the determined dimension and initial property of the building element, the method step 160 configures a building system for the building element to achieve a target property. For example, as mentioned above, the building system may be a covering, or it may be a replacement component, and the building system will be configured for the specific building element that was scanned.

The target property may be an improvement of the initial property, for example an improved thermal metric, or the target property may be configured to match the initial property, for example a matching appearance. Therefore, the target property may be the same as, or different from, the initial property.

In method step 160, configuring the building system may include selecting a building system from a database according to the dimension, the initial property and/or the target property of the building element. For example, if the initial property indicated a faulty or missing gutter, the method step 160 of configuring the building system may comprise selecting a replacement gutter component from a database based on the length of gutter component needed (dimension) and the colour (initial property).

Additionally or alternatively, the method step 160 of configuring the building system may comprise selecting a material and a quantity of the material for the building system. For example, if the building system were a render coating, as described above, selecting an amount of render required according to the determined dimension and determined initial property of the building element.

The instruction data generated in method step 170 preferably comprises control data for a computer-controller apparatus to fabricate at least a part of the building system. For example, the control data may be for the computer-controlled apparatus described elsewhere herein with reference to FIGS. 6 to 11, specifically the computer-controlled apparatus for applying a coating, such as render.

Alternatively or additionally, the method step 170 of generating instruction data may include generating instructions to be manually performed. For example, instructions for manual fabrication and/or installation for at least a part of the building system. The instruction data may comprise control data for a computer-controlled apparatus and instructions for manual fabrication tasks. For example, the instruction data may comprise control data for a CNC cutting machine to fabricate parts of a frame, and manual instructions for assembly of the parts of the frame into a frame.

The method 180 may comprise the further step of fabricating the building system in accordance with the instruction data generated in method step 170.

The step of fabricating the building system may comprise manufacturing and/or assembling the building system, and may further comprise installing the building system. As described with reference to FIGS. 13A to 13E, in one example method, a frame with insulation panels may be fabricated in a factory and later installed onto the building element, after which a coating, in the form of a render, can be applied to the insulation panels to provide a covering for the building element.

The method 180 can comprise additional scanning operations after the building system has been fabricated and/or installed, for example for quality control purposes. One or more quality control characteristics, such as a thermal metric, a visual appearance or a depth may be determined based on the further scan data. In some examples, a difference characteristic between the resultant property of the building element and the initial property of the building element may be determined based on the further scan data and the previous scan data generated in the first step 140.

FIG. 16 shows an alternative use for the electronic scanning apparatus, in which the scan data is processed in order to configure a building system for a building element in accordance with the method of FIG. 15. As shown in FIG. 16, the electronic scanning apparatus, which could be the electronic scanning apparatus 10,310,410, 510 of any of FIGS. 2 to 5, is used to scan a building 200 to generate scan data. In scanning the building 200, the electronic scanning apparatus 10,310,410, 510 will scan one or more building elements, for example walls 205a, 205c, windows 206, doors 207, roof 205b, and gutters 208. The scan data is therefore indicative of at least one building element of the building 200.

As per the method of FIG. 15, the scan data can then be processed to determine at least one dimension of one or more of the building elements, for example a dimension of a wall 205a and a dimension of a window 206. The dimension may include one or more of a height, a width and a depth of the building element, although it will be appreciated that different dimensions may be determined for different building elements.

As per the method of FIG. 15, the scan data can also be processed to determine an initial property of the building element. For example, for a wall 205a, the scan data may be processed to determine an integrity of the surface (e.g. cracks), or a colour of the wall 205a, or a material of the wall 205a. In another example, if the building element is a window 206, the scan data may be processed to determine a condition of the window 206, for example identifying missing or broken parts, or a material of the window 206, for example if the window frames are wooden, metal or plastic, and an appearance of the window 206, for example the configuration of individual window panes and other features, such as the frame colour.

As per the method of FIG. 15, the determined at least one dimension and the determined initial property of the building element, as determined by processing the scan data, is used to configure a building system for the building element. For example, in the example where the building element is a wall, the building system may be a covering to cover the wall. In the example where the building element is a window, the building system may be a replacement window. The building system is configured, that is selected or designed or sized, according to the determined initial property and according to the determined dimension. For example, if the determined initial property indicated poor thermal performance of a wall, then a covering including an insulation panel may be configured by thickness or thermal performance of the insulation panel, to improve thermal performance, and by the size of insulation panels to ensure that the wall is sufficiently covered. Configuration of the covering may further include determining the type and quantity of fixings required for the insulation panel. The type of fixings may be configured according to an initial structural property of the wall. Thus, the insulation panel building system is configured according to the determined initial property and the determined dimensions of the wall.

As per step 170 of the method of FIG. 15, instruction data is output after configuration of the building system. As explained previously, the instruction data may be in the form of control data of a computer-controlled apparatus for performing at least a part of the fabrication of the building system. Alternatively, the instruction data may be in the form of instructions for manual fabrication of at least a part of the building system. Alternatively, the instruction data may include a combination of control data for a computer-controlled apparatus, and manual instructions. Thus, according to this method, the scan data, which is of a building element, is processed to determine at least one dimension of the building element and an initial property of the building element. Thereafter, a building system is configured according to the at least one dimension and initial property, and instruction data is output for fabrication of the building system. This provides a method for taking the scan data and automatically configuring a building system that is specific to the building element. More than one initial property can be determined and considered in configuration of the building system.

FIG. 17 shows an alternative method 171 of using the data obtained by the apparatus illustrated in FIG. 16. In particular, the method 171 includes a step 172 of receiving scan data of an existing building element of an existing building, for example receiving the scan data from the electronic scanning apparatus 10,210,310, 410 of FIG. 16 used to scan an existing building, for example a house 200 as shown in FIG. 16. The method 171 then includes a step 173 of processing the scan data to determine at least one dimension of the existing building element and an initial property of the existing building element from the scan data. This is similar to other previously described methods.

According to the method 171 of FIG. 17, the method 171 also includes a step 174 of configuring one or more new building systems for a new building element having a target property. The one or more new building systems are configured according to the dimension of the existing building element and according to the initial property of the existing building element. In this way, the new building element is configured based on the scan data of the existing building element. The method 171 also includes the step 175 of generating instruction data for fabricating the one or more new building systems.

In this way, a new building element can be configured according to the scan data of the existing building 200, for example to have an appropriate size and/or to match an appearance of the existing building 200. In one example, the new building element may be a new wall, for example a wall of an extension, and the size and position of windows in that new wall can be configured to match the size and position of windows 206 in the existing building 200.

In some examples, the new building element is an extension for the existing building 200, the extension being configured for connection to the existing building element, for example a wall 205a of the building 200 in FIG. 16. In one example, the new building element may be a porch configured based on the scan data of the front wall 205c of the existing building 200. The porch is configured according to dimensions of the front wall 205c, and the positions of the windows 206 and the door 207, so that the porch fits with the existing building 200. The porch can also be configured according to an appearance of the front wall 205c of the existing building 200, for example a brick colour and arrangement. In this way, the method 171 provides instruction data for fabricating a porch for the existing building 200, based on the scan data of the exiting building 200.

Advantageously, the porch or other extension could be fabricated in an off-site location, for example in a factory, based on the generated instruction data. The fabricated porch can then be installed on the existing building 200.

In another example, the extension for the existing building 200 may be a new terraced house to be built on the end of an existing terraced house. The new terraced house may be configured to match the dimension and appearance of the existing terraced house by configuring the new terraced house based on the scan data of the existing terraced house, in particular the dimension and initial property of the existing terraced house, for example an appearance of the existing terraced house.

In other examples, the new building element may be a separate building to the existing building 200, for example a garage or an outbuilding. In this example, the new building element is not configured for connection to the existing building 200, but is configured according to the scan data of the existing building 200, in particular the dimension and the initial property determined from the scan data. In one example, the new building element may be a new building, for example a new house. In this example, the separate building may be at least a partial replica of the existing building 200. For example, scan data of an existing building 200 such as shown in FIG. 16 may be used to configure a new building to have the same size and appearance of the existing building 200. The new building can then be fabricated, according to the generated instructed data, for construction at any location.

The method 171 may further comprise a step of generating the scan data of the existing building, for example by using the scanning apparatus 10,210,310, 410 of FIG. 16.

The step 173 of determining at least one dimension of the existing building element comprises determining from the scan data one or more of a height, a width, and/or a depth of the existing building element or a part of the existing building element. The step 173 of determining an initial property of the existing building element comprises determining from the scan data a non-dimensional property of the existing building element, for example an appearance of the existing building element, a material of the existing building element, a condition of the existing building element, or a structure of the existing building element.

According to the determined dimension and initial property of the building element, the method step 174 configures at least one new building system for the new building element to achieve a target property. For example, as mentioned above, the new building element may be an extension, for example a porch, or the new building element may be a replica house, and the one or more new building systems will be configured based on the existing building element that was scanned.

The target property may be an improvement of the initial property, for example an improved thermal metric, or the target property may be configured to match the initial property, for example a matching appearance. Therefore, the target property may be the same as, or different from, the initial property.

In method step 174, configuring the one or more new building systems may include selecting one or more new building systems from a database according to the dimension and/or the initial property of the existing building element. For example, if the initial property indicated a particular brick colour and arrangement, then the method step 174 of configuring the one or more new building systems may comprise selecting a brick for use in the new building element.

The instruction data generated in method step 175 preferably comprises control data for a computer-controller apparatus to fabricate at least a part of the one or more new building systems, and may include control data for a computer-controlled apparatus to fabricate a plurality of new building systems to provide a new building element. For example, the control data may be for the computer-controlled apparatus described elsewhere herein with reference to FIGS. 6 to 11, specifically the computer-controlled apparatus for applying a coating, such as render.

Alternatively or additionally, the method step 175 of generating instruction data may include generating instructions to be manually performed. For example, instructions for manual fabrication and/or installation for at least a part of one or more of the new building systems. The instruction data may comprise control data for a computer-controlled apparatus and instructions for manual fabrication tasks. For example, the instruction data may comprise control data for a CNC cutting machine to fabricate parts of a frame, and manual instructions for assembly of the parts of the frame into a frame.

The method 171 may comprise the further step of fabricating the one or more new building systems in accordance with the instruction data generated in method step 174.

The step of fabricating the one or more new building systems may comprise manufacturing and/or assembling the one or more new building systems, and may further comprise installing the one or more new building systems and/or the new building element. As described with reference to FIGS. 13A to 13E, in one example method, a frame with insulation panels may be fabricated in a factory. This frame and insulation panels may be used to provide the wall of an extension or separate building, and can be assembled with other walls in a factory location or at an on-site location.

The method 171 can comprise additional scanning operations after the new building system has been fabricated and/or installed, for example for quality control purposes. One or more quality control characteristics, such as a thermal metric, a visual appearance or a depth may be determined based on the further scan data. In some examples, a difference characteristic between the resultant property of the new building element and the initial property of the existing building element may be determined based on the further scan data and the previous scan data generated in the first step 172 of the method 171.

Either or both of the electronic scanning apparatus and the computer-controlled apparatus can be controlled by a control unit, for example comprising one or more processors and a non-transient computer readable storage medium, sometimes referred to as a memory. The memory can include instructions which, when executed, cause the one or more processors to control either or both of the electronic scanning apparatus and the robotic device to operate as described herein. The control unit may be part of either or both of the electronic scanning apparatus and the robotic device, or may be separate to the electronic scanning apparatus and the robotic device.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for renovation works on a building including a plurality of building elements, the method comprising:
receiving scan data of a building element of the building;
processing the scan data to determine at least one dimension of the building element and an initial property of the building element from the scan data;
configuring a building system for the building element to achieve a target property of the building element, the building system being configured according to the dimension of the building element and according to the initial property of the building element; and
generating instruction data for fabricating the building system.

2. The method of claim 1, further comprising determining the target property from the initial property.

3. The method of claim 2, wherein the target property matches the initial property.

4. The method of claim 2, wherein the target property is different from the initial property.

5. The method of claim 1, further comprising receiving further scan data after fabrication of the building system, and processing the further scan data to assess a resultant property of the building system for quality control.

6. The method of claim 1, wherein the step of configuring the building system comprises includes selecting a building system from a database according to the initial property of the building element.

7. The method of claim 1, wherein the step of configuring the building system comprises includes selecting a material and a quantity of the material for the building system according to the at least one dimension of the building element and according to the initial property of the building element.

8. The method of claim 1, wherein the instruction data includes control data for a computer-controlled apparatus configured to fabricate at least a part of the building system in accordance with the control data.

9. The method of claim 1, wherein the building system includes a covering for the building element, for example a covering for a wall.

10. The method of claim 9, wherein the covering comprises includes a coating, for example render or plaster or roughcast.

11. The method of claim 1, wherein the building element includes an ancillary element of the building, for example one or more of:
a window, a window frame, a window sill, a fascia, a gutter, a tile, a panel, a fence, a railing, and/or a balustrade,
and wherein the building system includes a replacement for at least a part of the ancillary element.

12. The method of claim 1, further comprising fabricating the building system in accordance with the instruction data.

13. The method of claim 12, wherein fabricating the building system includes fabricating a least a part of the building system in a location remote from the building, for example in a factory, for subsequent installation on the building element.

14. The method of claim 12, wherein fabricating the building system includes fabricating the building element at the location of the building.

15. The method of claim 13, wherein fabricating the building system includes installation of the building system on the building element.

16. The method of claim 1, further comprising scanning the building element using electronic scanning apparatus to generate the scan data.

17. An apparatus for renovation works, the apparatus comprising:
electronic scanning apparatus for scanning a building element to generate scan data; and
a processor configured to perform the method of claim 1

18. The apparatus of claim 17, further comprising a computer-controlled apparatus for fabricating the building system in accordance with the instruction data.

19-22. (canceled)

23. A method of applying a covering to a building element of a building the method comprising:
receiving scan data of a building element of the building;
processing the scan data to determine an initial property of the building element from the scan data;
configuring a covering for the building element, the covering including a coating configured to achieve a target property of the building element;
generating control data to control a computer-controlled apparatus for applying the coating of the covering; and
controlling the computer-controlled apparatus for applying the coating in accordance with the control data.

24. The method of claim 23, wherein the coating is applied to the building element.

25. The method of claim 23, wherein the covering further includes insulation for attachment to the building element, and wherein the coating is applied to the insulation.

26. An apparatus for applying a covering to a building element of a building;
wherein the apparatus comprises:
an electronic scanning apparatus for generating scan data indicative of an initial property of the building element;
a computer-controlled apparatus for applying a coating of the covering; and
a processor configured to perform the method of claim 19.

27. The apparatus of claim 26, wherein the computer-controlled apparatus for applying the coating includes a material output nozzle for outputting a coating material, and an actuator to control a position of the material output nozzle.

28. The apparatus of claim 26, wherein the computer-controlled apparatus is portable, and is adapted for applying the coating on the building.
